(19) United States
(12) Patent Application Publication
(10) Pub. No.: US 2026/0171487 A1
(43) Pub. Date: Jun. 18, 2026

(54) SULFIDE-BASED SOLID ELECTROLYTE AND METHOD FOR REGENERATING THE SULFIDE-BASED SOLID ELECTROLYTE

(71) Applicants: HYUNDAI MOTOR COMPANY, Seoul (KR); Kia Corporation, Seoul (KR); Seoul National University R&DB Foundation, Seoul (KR)

(72) Inventors: Yong Jun JANG, Hwaseong-si (KR); Wo Dum JUNG, Hwaseong-si (KR); Dae Yeon HWANG, Hwaseong-si (KR); Young Sun KONG, Hwaseong-si (KR); Jong Woo LIM, Seoul (KR); Yu Jeong HWANG, Seoul (KR)

(21) Appl. No.: 19/424,337

(22) Filed: Dec. 18, 2025

(30) Foreign Application Priority Data
Dec. 18, 2024 (KR) 10-2024-0190379
Dec. 2, 2025 (KR) 10-2025-0188236

(51) Int. Cl. H01M 10/0562; H01M 4/02; H01M 4/525; H01M 10/54

(52) U.S. Cl. CPC H01M 10/0562; H01M 4/525; H01M 10/54; H01M 2004/028; H01M 2300/008

(57) ABSTRACT

An electrolyte composition includes a sulfide-based solid electrolyte having a surface layer comprising a phosphorous oxysulfide compound represented by a formula PSₓO_{y}, where x is an integer and y is an integer. The concentration of an oxygen (O) atom in the PSₓO_{y} is at least 15 atomic percent in an X-ray Photoelectron Spectroscopy (XPS) analysis.

### CROSS-REFERENCE TO RELATED APPLICATION

This application claims priority to and the benefit of Korean Patent Application No. 10-2024-0190379 filed on Dec. 18, 2024 and Korean Patent Application No 10-2025-0188236 filed on Dec. 2, 2025, the disclosures of each of which are incorporated herein by reference in their entirety.

### TECHNICAL FIELD

The present disclosure relates to a sulfide-based solid electrolyte and a method for regenerating a sulfide-based solid electrolyte.

### BACKGROUND

A lithium secondary battery employing a liquid electrolyte has been mainly employed as a secondary battery using lithium ions. The lithium secondary battery employing a liquid electrolyte generally comprises a negative electrode and a positive electrode separated by a separator including polymer and employs a liquid electrolyte as an electrolyte. However, in the lithium secondary battery employing such a liquid electrolyte, the electrolyte is present in the form of a liquid phase in the battery. Accordingly, various safety issues, such as the risk resulting from the higher volatility and the low thermal stability, can be caused.

Accordingly, an all-solid state battery has been continuously developed by employing, as the electrolyte of the lithium secondary battery, a solid electrolyte, instead of the liquid electrolyte. The all-solid state battery may include a negative electrode, a positive electrode, and a solid electrolyte, and all components of the all-solid state battery may be in a solid phase. Accordingly, the all-solid state battery can prevent safety issues resulting from the liquid electrolyte, and can be enhanced in energy and power through a series-connection, when compared to the lithium secondary battery employing the liquid electrolyte.

### SUMMARY

An aspect of the present disclosure enhances lithium-ion conductivity of a sulfide-based solid electrolyte by regenerating the surface of the sulfide-based solid electrolyte deteriorated due to the exposure to moisture.

Another aspect of the present disclosure provides a sulfide-based solid electrolyte regenerated even though the sulfide-based solid electrolyte is deteriorated due to moisture, such that the ion conductivity of the sulfide-based solid electrolyte is improved again.

Another aspect of the present disclosure provides a method for regenerating a sulfide-based solid electrolyte deteriorated due to moisture.

Another aspect of the present disclosure provides an electrode and a lithium secondary battery including the sulfide-based solid electrolyte.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, the present disclosure provides a sulfide-based solid electrolyte, an electrode, an all-solid state battery, and a method for regenerating the sulfide-based solid electrolyte. In some implementations, an electrolyte composition includes a sulfide-based solid electrolyte having a surface layer including a phosphorous oxysulfide compound represented by a formula PSₓO_{y}, wherein x is an integer and y is an integer, and wherein concentration of an oxygen (O) atom in the PSₓO_{y} is at least 15 atomic percent in an X-ray Photoelectron Spectroscopy (XPS) analysis.

In some implementations, a difference in concentration between the oxygen (O) atom and a sulfur (S) atom in the PSₓO_{y} present on the surface layer of the sulfide-based solid electrolyte is at least 6 atomic percent, based on the XPS analysis.

In some implementations, a ratio of PS₄³⁻ to PSₓO_{y} at P 2p in the XPS analysis with respect to the surface layer of the sulfide-based solid electrolyte is in a range from 1:1 to 18:1, based on the XPS analysis.

In some implementations, a ratio (AR/BE) of: (i) a value (AR) representing a ratio (Ie_{2,473}/I_{σ*}) of an intensity (Ie_{2,473}) of a peak identified at 2,473 eV to an intensity (I_{σ*}) of a peak identified in a range from 2,470.0 eV to less than 2,472.5 eV measured for the sulfide-based solid electrolyte after regeneration, to (ii) a value (BE) representing a ratio (Ie_{2,473}/I_{σ*}) of an intensity (I_{e2,473}) of a peak identified at 2,473 eV to an intensity (I_{σ*}) of a peak identified in the range from 2,470.0 eV to less than 2,472.5 eV measured for a sulfide-based solid electrolyte before regeneration, which has a same composition as the sulfide-based solid electrolyte, ranges from 1.00 to 1.18, based on a Sulfur K-edge analysis measured through a Tender X-ray Absorption Spectroscopy (XAS).

In some implementations, a ratio (I_{e2,473}/I_{σ*}) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte, ranges from 0.89 to 1.05, based on a Sulfur K-edge analysis measured through a Tender X-ray Absorption Spectroscopy (XAS).

In some implementations, a value of an intensity (I_{σ*}) of a peak identified in the range from 2,470.0 eV to less than 2,472.5 eV, measured for the sulfide-based solid electrolyte, ranges from 1.315 to 1.426, based on a Sulfur K-edge analysis measured through a Tender X-ray Absorption Spectroscopy (XAS).

In some implementations, a peak of PS₄³⁻ is observed at a vibration energy ranging from 425.6 cm⁻¹ to 426.3 cm⁻¹, based on a Raman Line scan analysis performed from a center of a particle of the sulfide-based solid electrolyte to a surface layer of the particle.

In some implementations, the sulfide-based solid electrolyte is represented by following Chemical formula 1 [Chemical formula 1] LiₐP_{b}S_{c}X_{d}, in Chemical formula 1, 4.0≤a≤6.0, 0.5≤b≤1.5, 3.0≤c≤9.0, and 0.5≤d≤2.0, and ‘X’ is at least one of Cl, Br, or I.

In some implementations, an electrode including the electrolyte composition according to claim 1, and an electrode active material.

In some implementations, an all-solid state battery includes a positive electrode; a negative electrode; and a solid electrolyte layer interposed between the positive electrode and the negative electrode, wherein at least one of the positive electrode, the negative electrode, and the solid electrolyte layer includes a sulfide-based solid electrolyte having a surface layer including a phosphorous oxysulfide compound represented by a formula PSₓO_{y}, wherein x is an integer and y is an integer, and wherein concentration of an oxygen (O) atom in the PSₓO_{y} is at least 15 atomic percent in an X-ray Photoelectron Spectroscopy (XPS) analysis.

In some implementations, a method for regenerating a sulfide-based solid electrolyte, the method including: preparing a sulfide-based solid electrolyte that has deteriorated due to moisture; placing the sulfide-based solid electrolyte deteriorated due to the moisture into a heating furnace; heating the heating furnace; maintaining the heating furnace to be in a heated state; and recovering the solid electrolyte after regeneration.

In some implementations, the method includes vacuumizing an inner part of the heating furnace before the heating.

In some implementations, the heating includes a process performed at a temperature increasing rate ranging from 1° C./min to 20° C./min.

In some implementations, a starting temperature of the heating ranges from 10° C. to 40° C.

In some implementations, a termination temperature of the heating ranges from 50° C. to 600° C.

In some implementations, maintaining the heating furnace includes a process performed at a termination temperature of the heating.

In some implementations, the method including allowing oxygen gas to flow in the heating furnace during the maintaining the heating furnace.

In some implementations, allowing the oxygen gas to flow in the heating furnace includes a process performed at a temperature a same as a temperature for the maintaining the heating furnace.

In some implementations, allowing the oxygen gas to flow in the heating furnace includes a process performed for a period of time that is at most 10% of a period of time for the maintaining the heating furnace.

In some implementations, a flow rate of the oxygen gas ranges from 10 sccm to 1,000 sccm.

### BRIEF DESCRIPTION OF THE DRAWINGS

The above and other objects, features and advantages of the present disclosure will be more apparent from the following detailed description taken in conjunction with the accompanying drawings:

FIG. 1A is a flowchart illustrating a method for regenerating a sulfide-based solid electrolyte according to an example of the present disclosure;

FIG. 1B is a flowchart illustrating a method for regenerating a sulfide-based solid electrolyte according to an example of the present disclosure;

FIG. 2 is a schematic view illustrating a method for regenerating a sulfide-based solid electrolyte according to an implementation of the present disclosure;

FIG. 3 is a graph representing the result of an AC impedance determined in Experimental example 1 of the present disclosure;

FIG. 4 is a graph representing the measurement result of an oxidation state of Ni determined in Experimental example 2 of the present disclosure;

FIG. 5 is an T×M image taken in Experimental example 2 of the present disclosure;

FIGS. 6 and 7 are graphs representing an initial discharge capacity of a cell determined in Experimental example 3 of the present disclosure;

FIG. 8 is a graph representing a discharge capacity as a function of a C-rate of a cell, which is determined in Experimental example 3 of the present disclosure;

FIGS. 9 to 12 are graphs illustrating an XPS analysis result determined in Experimental example 4 of the present disclosure;

FIGS. 13 and 14 are graphs illustrating an XPS analysis result determined in Experimental example 5 of the present disclosure;

FIG. 15 is a graph illustrating a Tender XAS analysis determined in Experimental example 6 of the present disclosure;

FIG. 16 illustrates a Raman analysis result for a sulfide-based solid electrolyte according to a comparative example 1 of the present disclosure;

FIG. 17 illustrates a Raman analysis result for a sulfide-based solid electrolyte according to an Example 1 of the present disclosure; and

FIGS. 18 and 19 are graphs representing XRD analysis results for a sulfide-based solid electrolyte according to Comparative example 1 of the present disclosure and a sulfide-based solid electrolyte according to Example 1 of the present disclosure.

### DETAILED DESCRIPTION

Hereinafter, the present disclosure will be described in more detail for the understanding of the present disclosure.

Among all-solid state lithium secondary batteries employing an inorganic solid electrolyte, a sulfide-based solid electrolyte may exhibit excellent ion conductivity and the excellent adhesion of an electrode active material. Accordingly, the sulfide-based solid electrolyte may be close to commercialization. However, the sulfide-based solid electrolyte, which can include lithium, phosphorus, sulfur, and halogen elements and has a cubic argyrodite-type crystal structure, may exhibit higher reactivity with moisture. Even if the sulfide-based solid electrolyte is stored in a place, such as a dry room, controlled in moisture, the sulfide-based solid electrolyte may react with moisture in the air to emit toxic gas (H₂S). In addition, the sulfide-based solid electrolyte may be deformed in structure due to the reaction with moisture as described above.

Accordingly, the sulfide-based solid electrolyte can be used only under an environment in which moisture is extremely removed. Accordingly, when the sulfide-based solid electrolyte is exposed to the air, a significantly dangerous situation can be caused due to the toxic gas, the ion conductivity can be rapidly lowered, and the higher overvoltage and the higher resistance due to the interface side-reaction can be appeared, thereby degrading the performance of the sulfide-based solid electrolyte. Accordingly, the sulfide-based solid electrolyte may have difficulty in implementing a mass production process essential for commercialization, and have a problem of increasing the production cost.

In addition, when a sulfide-based solid electrolyte that has been moisture-degraded and has by-products formed on its surface is used as such, without any pretreatment, to prepare a composite positive electrode and to form an interface with the positive electrode active material, a problem can arise in that the transition metal of the positive electrode active material is reduced, thereby causing collapse of the structure of the active material. Accordingly, it is necessary to secure interfacial stability by modifying the by-products or other substances formed on the surface of the sulfide-based solid electrolyte. Aspects of the present disclosure may address the above-discussed issues in the related art.

According to an example of the present disclosure, the sulfide-based solid electrolyte, an electrode, a lithium secondary battery, and/or a method for regenerating the sulfide-based solid electrolyte can comprise at least one of components described below, and an arbitrary combination of components, which are allowed technically, among following components

Aspects of the present disclosure provides a sulfide-based solid electrolyte.

The sulfide-based solid electrolyte can include an oxide layer formed on the surface of the sulfide-based solid electrolyte. The oxide layer can be formed by substituting oxygen (O) atom at a sulfur (S) site positioned on the surface of the sulfide-based solid electrolyte.

The sulfide-based solid electrolyte can include lithium, phosphorus, sulfur, and halogen and can have a cubic argyrodite-type crystal structure. The sulfide-based solid electrolyte can undergo a surface reaction, for example, even in a dry room atmosphere having the dew point of −50° C. and the absolute humidity of at most 47 mg/m³, which corresponds to a lower moisture concentration. In this case, a Li₃PS₄ compound produced through the moisture reaction is known as having a crystal form structured by a PS₄³⁻ tetrahedral arrangement, which can include equivalent P—S bonds of a single bond, to exhibit (only) one S 2p doublet and another P 2p doublet in an X-ray Photoelectron Spectroscopy (XPS) spectrum having the lower binding energy, based on an XPS analysis result. However, Li₃PS₄, which is amorphous, can have a structure in which tetrahedra are connected in a P₂S₆⁴⁻ unit containing an S—P—P—S bond to exhibit structural disorder, and can generate a doublet at a higher binding energy in the XPS spectrum. Meanwhile, Li₆PS₅Cl can include PS₄³⁻ tetrahedra and sulfur atoms separated at 4a and 4d sites. Accordingly, Li₆PS₅Cl theoretically can have one unique doublet for each element that appears in the XPS spectrum. In this case, an additional doublet generated from the unit of P₂Sₓ can be effectively observed for pure amorphous Li₃PS₄.

The ratio of a peak by PSₓO_{y} produced through elemental substitution by oxygen can be greatly increased when a sulfide-based solid electrolyte deteriorated due to moisture reaction on the surface is regenerated. A sulfide-based solid electrolyte, which is not deteriorated due to the moisture reaction, can exhibit a ratio of PS₄³⁻ to PSₓO_{y} at P 2p in a range from 18.5:1 to 99.0:1, with respect to the surface of the sulfide-based solid electrolyte, based on the XPS analysis result. However, the sulfide-based solid electrolyte can exhibit a ratio of PS₄³⁻ to PSₓO_{y} at P 2p in a range from 1:1 to 18:1 with respect to the surface of the sulfide-based solid electrolyte, based on the XPS analysis result. Specifically, based on the XPS analysis result, in the sulfide-based solid electrolyte, the ratio of PS₄³⁻ to PSₓO_{y} at P 2p can be at least 1.0:1, at least 1.5:1, at least 2.0:1, at least 2.5:1, at least 3.0:1, at least 3.5:1, at least 4.0:1, at least 4.5:1, at least 5.0:1, at least 6.0:1, or at least 6.5:1, and at most 18.0:1, at most 17.5:1, at most 17.0:1, at most 16.5:1, at most 16.0:1, at most 15.5:1, at most 15.0:1, at most 14.5:1, at most 14.0:1, at most 13.5:1, at most 13.0:1, at most 12.5:1, at most 12.0:1, at most 11.5:1, at most 11.0:1, at most 10.5:1, at most 10.0:1, at most 9.5:1, at most 9.0:1, at most 8.5:1, at most 8.0:1, at most 7.5:1, or at most 7.0:1, with respect to the surface of the sulfide-based solid electrolyte.

The sulfide-based solid electrolyte, which is not deteriorated due to the moisture reaction, can exhibit a ratio of PS₄³⁻ to Li₂S at S 2p in a range from 15:1 to 25:1, with respect to the surface of the sulfide-based solid electrolyte, based on the XPS analysis result. The sulfide-based solid electrolyte can exhibit a ratio of PS₄³⁻ to Li₂S at S 2p in a range from 25:1 to 35:1, with respect to the surface of the sulfide-based solid electrolyte, based on the XPS analysis result. Specifically, based on the XPS analysis result, in the sulfide-based solid electrolyte, the ratio of PS₄³⁻ to Li₂S at S 2p can be at least 25.0:1, at least 25.5:1, at least 26.0:1, at least 26.5:1, at least 27.0:1, or at least 27.5:1, and at most 35.0:1, at most 34.5:1, at most 34.0:1, at most 33.5:1, at most 33.0:1, at most 32.5:1, at most 32.0:1, at most 31.5:1, at most 31.0:1, at most 30.5:1, at most 30.0:1, at most 29.5:1, at most 29.0:1, at most 28.5:1, or at most 28.0:1, with respect to the surface of the sulfide-based solid electrolyte.

Based on the XPS analysis result, with respect to the surface of the sulfide-based solid electrolyte, the ratio of PS₄³⁻ to PSₓO_{y} at P 2p and the ratio of PS₄³⁻ to Li₂S at S 2p can indicate that the proportion of Li₂S, which is a representative example of a byproduct resulting from the deterioration due to moisture, is adjusted. This can indicate that the sulfide-based solid electrolyte deteriorated due to the moisture reaction is regenerated.

In the sulfide-based solid electrolyte, based on the XPS analysis result, PSₓO_{y} can be present on the surface of the sulfide-based solid electrolyte, and the concentration of oxygen atoms (O) in PSₓO_{y} can be at least 15 atomic %. For example, the concentration of oxygen atoms (O) in PSₓO_{y} can be at least 15 atomic %, at least 16 atomic %, at least 17 atomic %, at least 18 atomic %, at least 19 atomic %, or at least 20 atomic %. In addition, the concentration of oxygen atoms (O) of PSₓO_{y} can be at most 50 atomic %, at most 49 atomic %, at most 48 atomic %, at most 47 atomic %, at most 46 atomic %, at most 45 atomic %, at most 44 atomic %, at most 43 atomic %, at most 42 atomic %, at most 41 atomic %, at most 40 atomic %, at most 39 atomic %, at most 38 atomic %, at most 37 atomic %, at most 36 atomic %, at most 35 atomic %, at most 34 atomic %, at most 33 atomic %, at most 32 atomic %, at most 31 atomic %, at most 30 atomic %, at most 29 atomic %, at most 28 atomic %, at most 27 atomic %, at most 26 atomic %, at most 25 atomic %, at most 24 atomic %, at most 23 atomic %, or at most 22 atomic %. In the sulfide-based solid electrolyte, which is not deteriorated due to the moisture reaction, the concentration of oxygen atoms (O) on the surface of the sulfide-based solid electrolyte is less than 15 atomic %. However, when the sulfide-based solid electrolyte, which has a surface deteriorated due to the moisture reaction, is regenerated, especially, when oxygen (O) is substituted at the sulfur (S) site removable during the vacuum process in the vacuum-heating oxygen treatment, the concentration of oxygen (O) on the surface of the sulfide-based solid electrolyte can be increased. This can indicate that a novel surface layer in the form of an oxygen film is formed, as an atom of oxygen (O) is introduced into the surface of the sulfide-based solid electrolyte.

In the sulfide-based solid electrolyte, based on the XPS analysis result, the difference in concentration between an oxygen (O) atom and a sulfur (S) atom in PSₓO_{y} present on the surface of the sulfide-based solid electrolyte can be at least 6 atomic %. For example, the difference in concentration between an oxygen (O) atom and a sulfur (S) atom in PSₓO_{y} present on the surface of the sulfide-based solid electrolyte can be at least 6.0 atomic %, at most 6.5 atomic %, at least 7.0 atomic %, at least 7.5 atomic %, at least 8.0 atomic %, at least 8.5 atomic %, at least 9.0 atomic %, at least 9.5 atomic %, at least 10.0 atomic %, at least 10.5 atomic %, at least 11.0 atomic %, at least 11.5 atomic %, or at least 12.0 atomic %. In addition, the difference in concentration between an oxygen (O) atom and a sulfur (S) atom in PSₓO_{y} present on the surface can be at most 20.0 atomic %, at most 19.5 atomic %, at most 19.0 atomic %, at most 18.5 atomic %, at most 18.0 atomic %, at most 17.5 atomic %, at most 17.0 atomic %, at most 16.5 atomic %, at most 16.0 atomic %, at most 15.5 atomic %, at most 15.0 atomic %, at most 14.5 atomic %, at most 14.0 atomic %, at most 13.5 atomic %, at most 13.0 atomic %, or at most 12.5 atomic %. In the sulfide-based solid electrolyte, which is not deteriorated due to the moisture reaction, based on the XPS analysis result, the difference in concentration between an oxygen (O) atom and a sulfur (S) atom in PSₓO_{y} present on the surface of the sulfide-based solid electrolyte can be in the range from 0 atomic % to 6 atomic %. However, when the sulfide-based solid electrolyte, which has a surface deteriorated due to the moisture reaction, is regenerated, especially, when ‘O’ is substituted at the sulfur (S) site removable during the vacuum process in the vacuum-heating oxygen treatment, the concentration of oxygen (O) can be increased, but the concentration of sulfur (S) can be decreased, on the surface of the sulfide-based solid electrolyte. Accordingly, the difference in concentration between oxygen (O) and sulfur (S) can be more greatly increased. This can indicate that a novel surface layer in the form of an oxide layer is formed by substituting an O atom at a sulfur (S) site on the surface of the sulfide-based solid electrolyte.

The XPS analysis can be performed using AXIS Supra+ of Kratos Corp. The XPS analysis can be performed by maintaining a non-atmospheric exposure state through a chamber connected to a glove box during XPS measurement, with a step size at 0.1 eV, and by adjusting Ar sputtering conditions to use Ar⁺ mono ion at 5 keV energy and 12 mA emission current to measure an elemental ratio based on a depth. The XPS analysis result for the surface of the sulfide-based solid electrolyte can represent a result in a state in which an etching time is 0 seconds.

In a phosphorus oxysulfide represented by a Chemical formula of PSₓO_{y}, ‘x’ can be at least 0 and less than 4, and ‘y’ can be more than 0 and at most 4.

Through analysis using X-ray Absorption Spectroscopy (XAS), which is an analytical method used to identify an oxidation state and a local electronic structure of an atom, information about a chemical state of a sample can be obtained. A peak identified at at least 2,470.0 eV and less than 2,472.5 eV is a Sulfur K-edge main peak for a P atom and four S atoms adjacent to the P atom, and is a peak corresponding to σ⁺ orbital corresponding to a PS antibonding in tetrahedral local symmetry. When the sulfide-based solid electrolyte having a surface deteriorated due to a moisture reaction is regenerated and oxygen (O) is substituted at the sulfur (S) site, the Td symmetry is broken, so a σ⁺ band is broadened and split, such that distortion occurs, and an intensity of a peak identified at 2,473 eV can be increased. Although an overall signal intensity is decreased due to a decrease in the sulfur (S) atom removable in the vacuum process during vacuum heating oxygen treatment, the peak identified at 2,473 eV can be maintained, which can indicate that oxygen (O) is substituted at the sulfur (S) site. In general, the sulfide-based solid electrolyte including a PS₄ tetrahedron substitutes sulfur (S) and easily reacts with an oxygen (O) element in H₂O which forms a P—O bond and produces H₂S gas, in the argyrodite-type crystal structure. The inferior stability of the sulfide-based solid electrolyte as described above is caused by an oxyphilic property of ‘P’. When oxygen (O) is substituted at the sulfur (S) site, an oxy-sulfide of PSₓO_{y}³⁻ is formed in a crystal structure instead of the PS₄³⁻ tetrahedron. Accordingly, the oxygen (O) atom present at the sulfur (S) site can contribute to the air stability.

In the sulfide-based solid electrolyte, a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV, may not be lowered than Ie_{2,473}/I_{σ*} of a peak intensity identified in the sulfide-based solid electrolyte which is in the pristine state before the sulfide-based solid electrolyte is deteriorated by the moisture reaction on the surface, based on a Sulfur K-edge analysis result measured through the Tender XAS. The oxygen substitution may not completely suppress the relative intensity of a σ* mode. Accordingly, the regenerated sulfide-based solid electrolyte can be maintained to have a ratio at least equal to or greater than the ratio Ie_{2,473}/I_{σ*} observed in the sulfide-based solid electrolyte in the pristine state. In the sulfide-based solid electrolyte, a ratio (AR/BE) of (i) a value (AR) representing Ie_{2,473}/I_{σ*}, which is the ratio of the intensity (I_{e2,473}) of the peak identified at 2,473 eV to the intensity (I_{σ*}) of the peak identified in the range from 2,470.0 eV to less than 2,472.5 eV, measured for the sulfide-based solid electrolyte after regeneration, to (ii) a value (BE) representing a ratio (I_{e2,473}/I_{σ*}) of the intensity (I_{e2,473}) of the peak identified at 2,473 eV to the intensity (I_{σ*}) of the peak identified in the range from 2,470.0 eV to less than 2,472.5 eV, measured for the sulfide-based solid electrolyte before regeneration, which has the same composition as the sulfide-based solid electrolyte after regeneration, can be at least 1.00, at least 1.01, at least 1.02, at least 1.03, at least 1.04, or at least 1.05, depending on a Sulfur K-edge analysis result measured through the Tender XAS.

In the sulfide-based solid electrolyte, the ratio (AR/BE) of the value (AR) representing a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte after regeneration, to the value (BE) representing the ratio (Ie_{2,473}/I_{σ*}) of the intensity (I_{e2,473}) of the peak identified at 2,473 eV to an intensity (I_{σ*}) of a peak identified in the range from 2,470.0 eV to less than 2,472.5 eV, measured for the sulfide-based solid electrolyte before regeneration, which has the same composition as the sulfide-based solid electrolyte after regeneration, can be at most 1.18, at most 1.17, at most 1.16, at most 1.15, at most 1.14, at most 1.13, at most 1.12, at most 1.11, at most 1.10, at most 1.09, at most 1.08, at most 1.07, or at most 1.06, depending on a Sulfur K-edge analysis result measured through the Tender XAS.

In the sulfide-based solid electrolyte, the value (AR; after recovery/regeneration) representing a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte after regeneration, can range from 0.89 to 1.05, depending on a Sulfur K-edge analysis result measured through the Tender XAS. Specifically, in the sulfide-based solid electrolyte, a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte after regeneration, can be at most 1.05, at most 1.04, at most 1.03, at most 1.02, at most 1.01, at most 1.00, at most 0.99, at most 0.98, at most 0.97, at most 0.96, at most 0.95, or at most 0.94, depending on a Sulfur K-edge analysis result measured through the Tender XAS. When the sulfide-based solid electrolyte having the surface deteriorated due to the moisture reaction is regenerated, especially, when the vacuum heating oxygen treatment is performed, the ratio (Ie_{2,473}/I_{σ*}) of the peak intensity can have a tendency to be reduced to at most 1.05, especially, at most 1.00, as the electron structure of the sulfide-based solid electrolyte is changed. In addition, in the sulfide-based solid electrolyte, a ratio (Ie_{2,47}/I_{σ*}; AR; after recovery/regeneration) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte after regeneration, can be at least 0.89, at least 0.90, at least 0.91, at least 0.92, at least 0.93, or at least 0.94, depending on a Sulfur K-edge analysis result measured through the Tender XAS.

In the sulfide-based solid electrolyte, the intensity (I_{σ*}) of a peak identified in the range from 2,470.0 eV to less than 2,472.5 eV can range from 1.315 to 1.426, based on the Sulfur K-edge analysis result measured through the Tender XAS. The σ* peak (white line intensity) is an index which reflects the crystallinity of the sulfide-based solid electrolyte. In this case, the sulfide-based solid electrolyte, which is not exposed to the moisture, can exhibit the σ* peak (white line intensity) at the level of 1.427 based on the pre-edge/post-edge normalization, and the sulfide-based solid electrolyte having the surface deteriorated due to the moisture reaction can exhibit the σ* peak (white line intensity) decreased to the level of 1.314 based on the pre-edge/post-edge normalization. However, when the sulfide-based solid electrolyte is regenerated to partially recover the crystallinity, the intensity (I_{σ*}) of the peak identified in the range from 2,470.0 eV to less than 2,472.5 eV can range from 1.315 to 1.426, based on the Sulfur K-edge analysis result measured through the Tender XAS. Specifically, in the sulfide-based solid electrolyte, the intensity (I_{σ*}) of the peak identified in the range from 2,470.0 eV to less than 2,472.5 eV, measured for the sulfide-based solid electrolyte after regeneration can be at least 1.315, at least 1.316, at least 1.317, at least 1.318, at least 1.319, at least 1.320, at least 1.321, at least 1.322, at least 1.323, at least 1.324, at least 1.325, at least 1.326, at least 1.327, at least 1.328, at least 1.329, or at least 1.330, and at most 1.426, at most 1.420, at most 1.415, at most 1.410, at most 1.405, at most 1.400, at most 1.395, at most 1.390, at most 1.385, at most 1.380, at most 1.375, at most 1.370, at most 1.365, at most 1.360, at most 1.355, at most 1.350, at most 1.345, at most 1.340, at most 1.335, or at most 1.330, based on the Sulfur K-edge analysis result measured through the Tender XAS. The intensity (I_{σ*}) of the peak identified in the range from 2,470.0 eV to less than 2,472.5 eV can be varied depending on the composition (the composition ratio of Li, S, P, and X, a halide content, or an oxygen substitution ratio) of the sulfide-based solid electrolyte, based on the Sulfur K-edge analysis result measured through the Tender XAS.

In the sulfide-based solid electrolyte, the peak of PS₄³⁻ can be observed at vibration energy ranging from 425.6 cm⁻¹ to 426.3 cm⁻¹, based on a Raman Line scan analysis result measured from the center of a particle of the sulfide-based solid electrolyte to the surface of the particle. When the Raman Line scan analysis is performed from the center of a particle to the surface of the particle of the sulfide-based solid electrolyte, the symmetric stretching vibration mode of the PS₄³⁻ is stably observed under the vibration energy of 426.0 cm⁻¹ to 426.2 cm⁻¹, based on the peak fitting result. In the sulfide-based solid electrolyte having the surface deteriorated due to the moisture reaction, partial oxygenation of a PS₄ motif can be made on the surface. Accordingly, the peak can be shifted in the direction of the lower wavenumber, toward the surface region, and broadening can be observed in which the whole full width is increased. Accordingly, the peak can be shifted toward the center from the surface, and the peak shift can appear up to at least 1 cm⁻¹. However, when the sulfide-based solid electrolyte having the surface deteriorated due to the moisture reaction is regenerated such that oxygen (O) is substituted at the sulfur (S) site, the PS₄, a structure having the surface deteriorated due to the moisture, can be partially recovered to form PSₓO_{y}. Accordingly, even if the peak shift is made in the direction of the lower wavenumber, the variation range of the peak position can be significantly reduced. In the sulfide-based solid electrolyte, the peak of PS₄³⁻ can be observed at the vibration energy ranging from 425.6 cm⁻¹ to 426.3 cm⁻¹, based on the Raman Line scan analysis result measured from the center of the particle to the surface of the particle of the sulfide-based solid electrolyte. In addition, in the sulfide-based solid electrolyte, the difference in peak between the center and the surface can be at most 0.6 cm⁻¹, based on the Raman Line scan analysis result measured from the center of the particle to the surface of the particle. This can indicate that the peak variation is reduced by about 40% when compared to the sulfide-based solid electrolyte having the surface deteriorated due to the moisture reaction, and that the surface structure can be prevented from being distorted, as the sulfide-based solid electrolyte can be regenerated to recover the vibration environment to be similar to that of the particles of the sulfide-based solid electrolyte not exposed to the moisture.

In some implementations, the sulfide-based solid electrolyte according to an example of the present disclosure can have the unit structure of PS₄.

In some implementations, the sulfide-based solid electrolyte according to an example of the present disclosure can be represented by following Chemical formula 1.

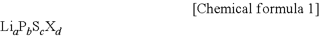

In Chemical formula 1, ‘X’ can be at least one of F, Cl, Br, or I. When ‘X’ includes at least two of F, Cl, Br, and I, the at least two elements can be included together within a molar ratio range represented by ‘d’. In this case, ‘a’ can be a real number ranging from 3 to 7, ‘b’ can be a real number ranging from 0.1 to 1.5, ‘c’ can be a real number ranging from 3 to 9, and ‘d’ can be a real number ranging from 0.1 to 2.0.

The ‘a’ can be the composition ratio of Li in the sulfide-based solid electrolyte, and be at least 3.0, at least 3.5, at least 4.0, at least 4.5, at least 5.0, at least 5.5, or at least 6.0, and can be at most 9.0, at most 8.5, at most 8.0, at most 7.5, at most 7.0, at most 6.5, or at most 6.0.

The ‘b’ can be the composition ratio of P in the sulfide-based solid electrolyte, and be at least 0.1, at least 0.2, at least 0.3, at least 0.4, at least 0.5, at least 0.6, at least 0.7, at least 0.8, at least 0.9, or at least 1.0, and can be at most 1.5, at most 1.4, at most 1.3, at most 1.2, at most 1.1, or at most 1.0.

The ‘c’ can be the composition ratio of S in the sulfide-based solid electrolyte, and be at least 3.0, at least 3.5, at least 4.0, or at least 4.5, and can be at most 6.0, at most 5.9, at most 5.8, at most 5.7, at most 5.6, at most 5.5, at most 5.4, at most 5.3, at most 5.2, at most 5.1, or at most 5.0.

The ‘d’ can be the composition ratio of ‘X’ in the sulfide-based solid electrolyte, and be at least 0.1, at least 0.2, at least 0.3, at least 0.4, at least 0.5, at least 0.6, at least 0.7, at least 0.8, at least 0.9, or at least 1.0, and can be at most 2.0, at most 1.9, at most 1.8, at most 1.7, at most 1.6, or at most 1.5.

In the sulfide-based solid electrolyte, Li, P, S, and/or X can be substituted with a doping element within the composition range represented by the Chemical formula 1.

The sulfide-based solid electrolyte can include at least one of Li₆PS₅, Li₃PS₄, Li₁₀GeP₂Si₂, ThioLISICON (Li_{3.25}Ge_{0.25}P_{0.75}S₄), Li₂S—P₂S₅—LiCl, Li₂S—SiS₂, LiI—Li₂S—SiS₂, LiI—Li₂S—P₂S₅, LiI—Li₂S—P₂O₅, LiILi₃PO₄—P₂S₅, Li₂S—P₂S₅, LiP₃S₁₁, LiI—Li₂S—B₂S₃, Li₃PO₄—Li₂S—Si₂S, Li₃PO₄—Li₂S—SiS₂, LiPO₄—Li₂S—SiS, Li_{9.54}Si_{1.74}P_{1.44}S_{1.7}Cl_{0.3}, Li₇P₃S₁₁, Li₆PS₅Cl_{0.5}Br_{0.5}, Li₆PS₅Cl, or Li₆PS₅Br, and Li₆PS₅I.

The oxide layer can be formed by a method for regenerating the sulfide-based solid electrolyte to be described below. The oxide layer can include PSₓO_{y}.

The sulfide-based solid electrolyte can be an argyrodite-type sulfide-based solid electrolyte. The composition of the sulfide-based solid electrolyte except for the oxide layer can be the same as those of the sulfide-based solid electrolyte represented by Chemical formula 1 or as described in the implementations.

When the sulfide-based solid electrolyte includes the oxide layer, the sulfide-based solid electrolyte represented by the Chemical formula 1 can be represented by following Chemical formula 2 as the entire sulfide-based solid electrolyte.

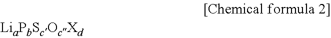

In Chemical formula 2, ‘X’, ‘a’, ‘b’, and ‘d’ are as defined in Chemical formula 1. The c′ is the composition ratio of sulfur (S) in the sulfide-based solid electrolyte when oxygen (O) is substituted at the sulfur (S) site, and can be at least 3.0, at least 3.5, at least 4.0, or at least 4.5, and at most 6.0, at most 5.9, at most 5.8, at most 5.7, at most 5.6, at most 5.5, at most 5.4, at most 5.3, at most 5.2, at most 5.1, or at most 5.0. The c″ is the composition ratio of oxygen (O) in the sulfide-based solid electrolyte when oxygen (O) is substituted at the sulfur (S) site, and can be at least 0.01, at least 0.02, at least 0.03, at least 0.04, at least 0.05, at least 0.06, at least 0.07, at least 0.08, at least 0.09, or at least 0.10, and can be at most 1.0, at most 0.9, at most 0.8, at most 0.7, at most 0.6, or at most 0.5.

In the sulfide-based solid electrolyte, Li, P, S, and/or X can be substituted with a doping element within the composition range represented by the Chemical formula 2.

Aspects of the present disclosure provides an electrode.

The electrode can be a positive electrode or a negative electrode. The positive electrode or negative electrode can include the sulfide-based solid electrolyte described above or an electrode active material.

The positive electrode can include a positive electrode current collector and a positive electrode active material layer disposed on the positive electrode current collector. The positive electrode active material layer can include a positive electrode active material including a lithium transition metal composite oxide including nickel.

The lithium transition metal composite oxide can be represented by following Chemical formula 3.

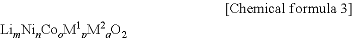

In the Chemical formula 3, M¹ can include Mn, Al, or a combination thereof, M² can include the element selected from the known doping element applicable to the positive electrode active material, 0.9≤m≤1.1, 0<n<1, 0<o<1, 0<p<l, 0≤q<0.2, and n+o+p+q=1.

The lithium transition metal composite oxide can include at least one of LiCoO₂, LiNi_{0.5}Co_{0.2}Mn_{0.3}O₂, LiNiO₂, LiCoPO₄, LiFePO₄, LiMn₂O₄, LiMnPO₄, LiFe₁₋ₓMnₓPO₄ (0<x≤0.8), LiVOPO₄, Li₃V₂ (PO₄)₃, LiNi_{0.5}Mn_{0.5}O₂, LiₓM₂(PO₄)₃ (M=Fe or Ti, 0<x≤3), or Li₄₊ₓMn₅O₁₂ (0<x≤3).

The positive electrode current collector is not specifically limited, as long as the positive electrode current collector includes a metal having higher conductivity, allows the positive electrode active material layer to be easily bonded to the positive electrode current collector, and has no reactivity in a voltage range of the all-solid state battery. Specifically, the positive electrode current collector can be stainless steel, aluminum, nickel, titanium, fired carbon, or aluminum or stainless steel which is surface-treated with carbon, nickel, titanium, and silver. In addition, the positive electrode current collector can have the thickness ranging from about 3 [symbol] to about 500 [symbol] . In addition, a fine roughness can be formed on the surface of the positive electrode current collector or the surface of the positive electrode current collector can be surface-treated to increase the bonding force with the positive electrode active material. In addition, the positive electrode current collector can be used in various forms such as a film, a sheet, a foil, a net, a porous material, a foam, or a non-woven fabric.

The positive electrode active material layer can selectively include a binder and a conductive material, together with the positive electrode active material and the sulfide-based solid electrolyte. In this case, the positive electrode active material can be included in an amount ranging from 50 wt % to 99 wt %, based on the total weight of the positive electrode active material layer. Within the range, the superior capacity characteristic and the improved energy density can be exhibited.

The sulfide-based solid electrolyte can be the argyrodite-type sulfide-based solid electrolyte and can be the sulfide-based solid electrolyte described above. In addition, the sulfide-based solid electrolyte can be the same as or different from a solid electrolyte included in a solid electrolyte layer of the all-solid state battery. In this case, the sulfide-based solid electrolyte can be included in an amount ranging from 1 wt % to 50 wt, based on the total weight of the positive electrode active material layer.

When the positive electrode active material layer includes a binder, the binder can be a component which supports the bonding between components, such as the positive electrode active material, the solid electrolyte, and the conductive material, of the positive electrode active material layer, and can be at least one of poly(vinylidene fluoride-hexafluoropropylene) copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butyrene rubber (SBR), or fluorine rubber.

When the positive electrode active material layer includes the conductive material, the conductive material can have conductivity without inducing a chemical change in the lithium secondary battery. Specifically, the conductive material can include graphite such as natural graphite or artificial graphite; carbon black such as acetylene black, ketjen black, channel black, furnace black, lamp black, or thermal black; a conductive fiber such as a carbon fiber or a metal fiber; fluorocarbon; metal powders such as aluminum or nickel powders; conductive whisker such as zinc oxide or potassium titanate; a conductive metal oxide such as a titanium oxide; a conductive material, such as a polyphenylene derivative.

The negative electrode can include a negative electrode current collector and a negative electrode active material layer formed on at least one surface of the negative electrode current collector.

The negative electrode current collector is not specifically limited, as long as the negative electrode current collector includes a metal having higher conductivity, allows the negative electrode active material layer to be easily bonded to the negative electrode current collector, and has no reactivity in a voltage range of the all-solid state battery. Specifically, the negative electrode current collector can be copper stainless steel, aluminum, nickel, titanium, fired carbon, or aluminum or stainless steel surface-treated with carbon, nickel, titanium, and silver. In addition, the negative electrode current collector can have the thickness ranging from about 3 [symbol] to about 500 [symbol] . In addition, a fine roughness can be formed on the surface of the negative electrode current collector or the surface of the negative electrode current collector is surface-treated to increase the bonding force with the negative electrode active material. In addition, the negative electrode current collector can be used in various forms such as a film, a sheet, a foil, a net, a porous material, a foam, or a non-woven fabric.

According to an implementation of the present disclosure, the negative electrode active material layer can selectively include a solid electrolyte, a binder, and a conductive material, together with the negative electrode active material.

The negative electrode active material can be a compound which enables reversible intercalation and deintercalation of the lithium. Specifically, the negative electrode active material layer can include at least one negative electrode active material including a carbon-based negative electrode active material, a silicon-based negative electrode active material, and/or a lithium metal negative electrode active material. More specifically, the negative electrode active material can include a carbon-based negative electrode active material, such as artificial graphite, natural graphite, graphitized carbon fiber, and amorphous carbon; silicon-based negative electrode active material, such as an Si, an Si alloy, and SiOₓ (0<x<2); a metallic compound, such as Al, Sn, Pb, Zn, Bi, In, Mg, Ga, Cd, an Si alloy, an Sn alloy, or an Al alloy capable of alloying with lithium, a metal oxide, such as SnO₂, a vanadium oxide, or a lithium vanadium oxide, for doping and de-doping lithium; a composite, such as a Si—C composite or a Sn—C composite, including the metal-based compound and a carbonaceous material, or a mixture of any one or at least two of the above materials. In addition, the negative electrode active material can include a lithium metal thin film which is a lithium metal negative electrode active material. In addition, the carbon-based negative electrode active material can include low crystalline carbon and high crystalline carbon. The low crystalline carbon can include soft carbon and hard carbon. The high crystalline carbon can include high-temperature fired carbon such as amorphous, plate-like, flaky, spherical, or fibrous natural or artificial graphite, kish graphite, pyrolytic carbon, meso-phase pitch-based carbon fiber, meso-carbon microbeads, mesophase pitches, and petroleum or coal tar pitch-derived cokes.

The negative electrode active material layer can selectively include a binder and a conductive material, together with the negative electrode active material and the sulfide-based solid electrolyte. In this case, the negative electrode active material can be included in an amount ranging from 50 wt % to 99 wt %, based on the total weight of the negative electrode active material layer. When the content of the negative electrode active material is within the range, the excellent capacity characteristic and the improved energy density can be exhibited.

The sulfide-based solid electrolyte can be an argyrodite-type sulfide-based solid electrolyte and can be the sulfide-based solid electrolyte described above. In addition, the sulfide-based solid electrolyte can be the same as or different from a solid electrolyte included in a solid electrolyte layer of the all-solid state battery. The sulfide-based solid electrolyte can be included in an amount ranging from 1 wt % to 50 wt %, based on the total weight of the negative electrode active material layer.

According to an implementation of the present disclosure, when the negative electrode active material layer includes a binder, the binder can be a component which supports the bonding between components, such as the negative electrode active material, the solid electrolyte, and the conductive material, of the negative electrode active material layer, and can be at least one of poly(vinylidene fluoride-hexafluoropropylene) copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butyrene rubber (SBR), or fluorine rubber.

According to an implementation of the present disclosure, when the negative electrode active material layer includes the conductive material, the conductive material can have conductivity without inducing a chemical change in the lithium secondary battery. Specifically, the conductive material can include graphite such as natural graphite or artificial graphite; carbon black such as acetylene black, ketjen black, channel black, furnace black, lamp black, or thermal black; a conductive fiber such as a carbon fiber or a metal fiber; fluorocarbon; metal powders such as aluminum or nickel powders; conductive whisker such as zinc oxide or potassium titanate; a conductive metal oxide such as a titanium oxide; a conductive material, such as a polyphenylene derivative.

Aspects of the present disclosure provides a solid electrolyte layer including the solid electrolyte.

The solid electrolyte layer can include the sulfide-based solid electrolyte, and can selectively a binder together with the solid electrolyte.

The solid electrolyte can be the same as or different from the sulfide-based solid electrolyte included in the positive electrode active material layer described above and/or the sulfide-based solid electrolyte included in the negative electrode active material layer. Specifically, the solid electrolyte included in the solid electrolyte layer can include at least one of a sulfide-based solid electrolyte, an oxide-based solid electrolyte, a chloride-based solid electrolyte, or a polymer solid electrolyte. More specifically, the solid electrolyte can be argyrodite-type sulfide-based solid electrolyte. In addition, the solid electrolyte of the solid electrolyte layer can be the sulfide-based solid electrolyte described above.

When the solid electrolyte layer includes a binder, the binder can be a component which supports the bonding between solid electrolytes, and can be at least one of poly(vinylidene fluoride-hexafluoropropylene) copolymer (PVDF-co-HEP), polyvinylidenefluoride, polyacrylonitrile, polymethylmethacrylate, polyvinyl alcohol, carboxymethylcellulose (CMC), starch, hydroxypropyl cellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butyrene rubber (SBR), or fluorine rubber.

Aspects of the present disclosure provides a lithium secondary battery.

The lithium secondary battery can be an all-solid state battery. Specifically, the lithium secondary battery can include a positive electrode, a negative electrode, a solid electrolyte layer interposed between the positive electrode and the negative electrode. At least one of the positive electrode, the negative electrode, and the solid electrolyte layer can include the sulfide-based solid electrolyte described above.

The lithium secondary battery according to an example of the present disclosure can be used in the field of electric vehicles, such as a hybrid electric vehicle (HEVs) and an electric vehicle (EV). The lithium secondary battery including the positive electrode active material according to an example of the present disclosure can stably exhibit the excellent capacity characteristic, the excellent power characteristic, and the excellent lifespan characteristic.

The outer appearance of the lithium secondary battery according to an example of the present disclosure is not particularly limited. The lithium secondary battery can have a cylindrical shape using a can, a prismatic shape, a pouch-type shape, or a coin-type shape. In addition, the lithium secondary battery can be used in the form of a unit cell in a medium or large-sized battery module including a plurality of battery cells. Accordingly, Aspects of the present disclosure provides a battery module employing the lithium secondary battery as a unit cell and a battery pack including the battery module.

The battery module or battery pack can be used as a power source of a medium or large-sized device including at least any one of a power tool; an electric vehicle including an electric vehicle (EV), a hybrid electric and a plug-in hybrid electric vehicle (PHEV); or a power storage system.

Aspects of the present disclosure provides a method for regenerating the sulfide-based solid electrolyte.

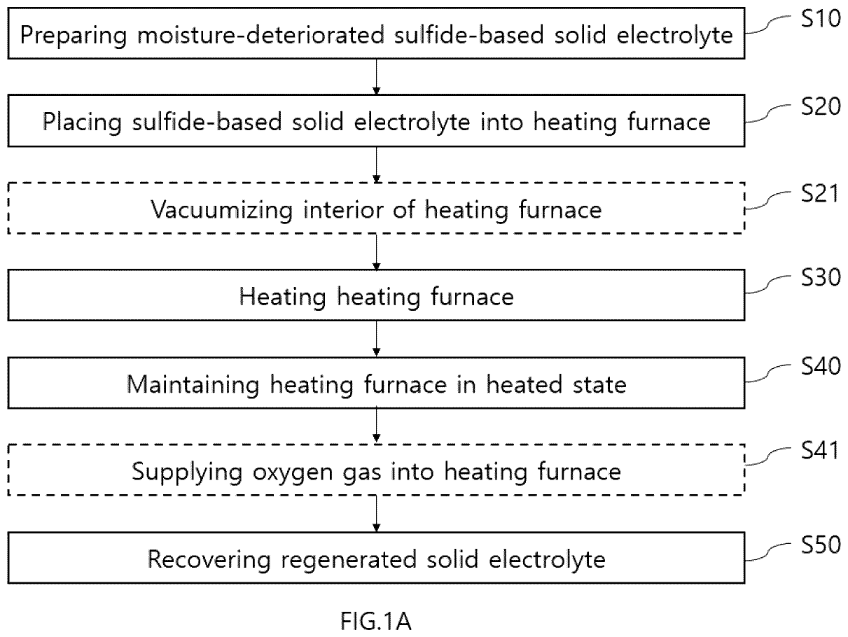

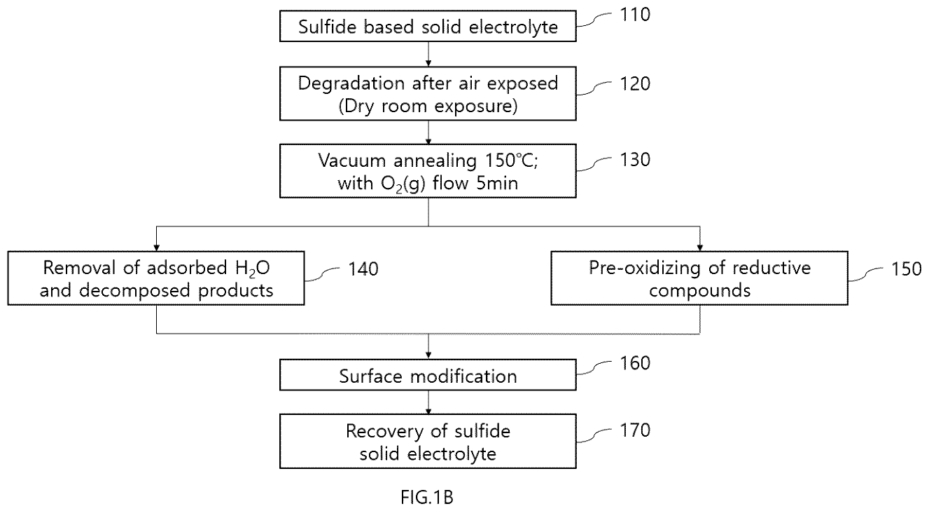

Referring to FIG. 1A, the method for regenerating the sulfide-based solid electrolyte can include a step (S10) of preparing a sulfide-based solid electrolyte deteriorated due to moisture, a step (S20) of placing the sulfide-based solid electrolyte deteriorated due to the moisture into a heating furnace, a step (S30) of heating the heating furnace, a step (S40) of maintaining the heating furnace to be in a heated state, and a step (S50) of recovering a solid electrolyte regenerated. As described above, when the sulfide-based solid electrolyte is regenerated, the lithium-ion conductivity of the sulfide-based solid electrolyte can be recovered, and the driving performance of the all-solid state battery including the sulfide-based solid electrolyte as the solid electrolyte can be recovered.

The step (S10) can be to prepare a sulfide-based solid electrolyte exposed to the moisture and having a byproduct produced on the surface thereof, and to prepare a sulfide-based solid electrolyte to be regenerated through the method for regenerating the sulfide-based solid electrolyte of the present disclosure. The sulfide-based solid electrolyte deteriorated due to moisture can employ all sulfide-based solid electrolytes as long as the sulfide-based solid electrolytes are exposed to moisture.

The step (S20) can be to place the sulfide-based solid electrolyte into the heating furnace to perform the method for regenerating the sulfide-based solid electrolyte. In this case, the heating furnace can employ a tube furnace, based on the vacuum maintained and oxygen flowing. The tube furnace can include a tube including alumina to form the inner part of the heating furnace.

The step (S30) can be performed in a vacuum state to increase the efficiency of removing foreign substances present on the surface of the sulfide-based solid electrolyte placed in the heating furnace and deteriorated due to moisture. Accordingly, the method for regenerating the sulfide-based solid electrolyte can include a step (S21) for vacuumizing the inner part of the heating furnace before performing the step (S30). The vacuumizing of the step (S21) can be performed by connecting the inner part of the heating furnace to the vacuum pump.

The heating in the step (S30) can be performed at a temperature increasing rate ranging from 1° C./min to 20° C./min. Specifically, the temperature increasing rate can be at least 1° C./min, at least 2° C./min, at least 3° C./min, at least 4° C./min, or at least 5° C./min, and can be at most 20° C./min, at most 19° C./min, at most 18° C./min, at most 17° C./min, at most 16° C./min, at most 15° C./min, at most 14° C./min, at most 13° C./min, at most 12° C./min, at most 11° C./min, at most 10° C./min, at most 9° C./min, at most 8° C./min, at most 7° C./min, at most 6° C./min, or at most 5° C./min. When the temperature increasing rate is adjusted to be in the above range, a large temperature gradient can be prevented from being formed between the inner part and the surface of the sulfide-based solid electrolyte, thereby preventing the thermal stress from being locally increased. Accordingly, the sulfide-based solid electrolyte can be prevented from being cracked or finely cracked. Further, the temperature increasing rate can adjust the evaporation of surface atoms under the vacuum condition to prevent the vacancy and/or defects from being formed, thereby preventing defects from being formed while more effectively inducing the structure recovery.

The starting temperature for the heating in the step (S30) can range from 10° C. to 40° C. Specifically, the starting temperature can be at least 10° C., at least 11° C., at least 12° C., at least 13° C., at least 14° C., at least 15° C., at least 16° C., at least 17° C., at least 18° C., at least 19° C., at least 20° C., at least 21° C., at least 22° C., at least 23° C., at least 24° C., at least 25° C., at least 26° C., at least 27° C., at least 28° C., at least 29° C., or at least 30° C., and can be at most 40° C., at most 39° C., at most 38° C., at most 37° C., at most 36° C., at most 35° C., at most 34° C., at most 33° C., at most 32° C., at most 31° C., or at most 30° C. When the starting temperature is adjusted to be in the above range, a large temperature gradient can be prevented from being formed between the inner part and the surface of the sulfide-based solid electrolyte, thereby preventing the thermal stress from being locally increased. Accordingly, the sulfide-based solid electrolyte can be prevented from being cracked or finely cracked, which is similar to the effects of the temperature increasing rate.

The terminating temperature for the heating in the step (S30) can range from 50° C. to 600° C. Specifically, the terminating temperature can be at least 50° C., at least 60° C., at least 70° C., at least 80° C., at least 90° C., at least 100° C., at least 110° C., at least 120° C., at least 130° C., at least 140° C., or at least 150° C., and can be at most 600° C., at most 590° C., at most 580° C., at most 570° C., at most 560° C., at most 550° C., at most 540° C., at most 530° C., at most 520° C., at most 510° C., at most 500° C., at most 490° C., at most 480° C., at most 470° C., at most 460° C., at most 450° C., at most 440° C., at most 430° C., at most 420° C., at most 410° C., at most 400° C., at most 390° C., at most 380° C., at most 370° C., at most 360° C., at most 350° C., at most 340° C., at most 330° C., at most 320° C., at most 310° C., at most 300° C., at most 290° C., at most 280° C., at most 270° C., at most 260° C., at most 250° C., at most 240° C., at most 230° C., at most 220° C., at most 210° C., at most 200° C., at most 190° C., at most 180° C., at most 170° C., at most 160° C., or at most 150° C. When the terminating temperature is adjusted to be in the above range, the terminating temperature is adjusted to prevent the sulfide-based solid electrolyte from exceeding the inherent thermodynamic stability limit of the sulfide-based solid electrolyte. Accordingly, even if the bonding between components is weakened, the thermal decomposition can be prevented. In addition, the atomic dispersion degree can be prevented from being abnormally increased during the heat-treatment process, and anisotropic growth, in which only a specific crystal gain is selectively and rapidly grown, can be suppressed, thereby maintaining the whole uniformity of the fine structure while increasing the local defect concentration, such that mechanical vulnerability can be prevented or suppressed.

The step (S40) can be performed to maintain the heating furnace to be still in a state in which heating is finished after heating is terminated, that is, in a heated state, in which the heating furnace is maintained in the heated state to more efficiently remove the byproduct from the surface of the sulfide-based solid electrolyte deteriorated due to moisture. In other words, ‘S40’ can be performed at the terminating temperature of the heating in ‘S30’.

The step (S40) can be performed at a temperature ranging from 50° C. to 600° C. Specifically, the temperature maintained in ‘S40’ can be at least 50° C., at least 60° C., at least 70° C., at least 80° C., at least 90° C., at least 100° C., at least 110° C., at least 120° C., at least 130° C., at least 140° C., or at least 150° C., and can be at most 600° C., at most 590° C., at most 580° C., at most 570° C., at most 560° C., at most 550° C., at most 540° C., at most 530° C., at most 520° C., at most 510° C., at most 500° C., at most 490° C., at most 480° C., at most 470° C., at most 460° C., at most 450° C., at most 440° C., at most 430° C., at most 420° C., at most 410° C., at most 400° C., at most 390° C., at most 380° C., at most 370° C., at most 360° C., at most 350° C., at most 340° C., at most 330° C., at most 320° C., at most 310° C., at most 300° C., at most 290° C., at most 280° C., at most 270° C., at most 260° C., at most 250° C., at most 240° C., at most 230° C., at most 220° C., at most 210° C., at most 200° C., at most 190° C., at most 180° C., at most 170° C., at most 160° C., or at most 150° C. When the maintained temperature is adjusted to be in the above range, similarly to the effects of the terminating temperature, the maintained temperature is adjusted to prevent the sulfide-based solid electrolyte from exceeding the inherent thermodynamic stability limit of the sulfide-based solid electrolyte. Accordingly, even if the bonding between components is weakened, the thermal decomposition can be prevented. In addition, the atomic dispersion degree can be prevented from being abnormally increased during the heat-treatment process, and anisotropic growth, in which only a specific crystal gain is selectively and rapidly grown, can be suppressed, thereby maintaining the whole uniformity of the fine structure while increasing the local defect concentration, such that mechanical vulnerability can be prevented or suppressed.

The time for maintaining the heating furnace in the heated state in the step (S40) can be increased in proportion to the content of the sulfide-based solid electrolyte introduced in the heating furnace. Specifically, the maintaining time in ‘S40’ can range from 5 minutes to 10 hours. More specifically, the maintaining time in ‘S40’ can be at least 5 minutes, at least 10 minutes, at least 20 minutes, at least 30 minutes, at least 40 minutes, at least 50 minutes, at least 60 minutes, at least 70 minutes, at least 80 minutes, at least 90 minutes, at least 100 minutes, at least 110 minutes, or at least 120 minutes, and can be at most 10 hours, at most 9 hours, at most 8 hours, at most 7 hours, at most 6 hours, at most 5 hours, at most 4 hours, at most 3 hours, or at most 2 hours.

The step (S40) can be performed by including the step (S41) for allowing oxygen gas to flow into the heating furnace while the heating furnace is maintained in the heated state in the step (S40). The step (S41), which is to form a novel surface layer in the form of an oxygen layer by substituting an oxygen (O) atom at the sulfur (S) site on the surface of the sulfide-based solid electrolyte, after removing a byproduct on the surface of the sulfide-based solid electrolyte deteriorated due to moisture in the step (S30) and the step (S40), as much as possible, can be performed during the maintaining of the heating furnace in the heated state in the step (S40). In other words, the step (S41) can be performed at a temperature the same as the temperature for maintaining the heating furnace in the heated state in the step (S40). Accordingly, the step (S41) can be considered as being performed during the maintaining of the heating furnace in the heated surface in the step (S41). Alternatively, after the maintaining of the heating furnace in the heated surface in the step (S40) is terminated, the step (S41) can be considered as being performed separately at the same temperature. When the step (S41) is performed as described above, especially, when the sulfide-based solid electrolyte is applied to the positive electrode, a substance, which has a significantly strong reducing power for reducing the transition metal during the forming of the interface with the transition metal of the positive electrode active material, can be first oxidized.

The step (S41) can be performed for a time of at most 10% of the total maintaining time in the step (S40). In this case, the novel surface layer in the form of the oxide layer can be properly formed by substituting the oxygen (O) atom at the sulfur (S) site on the surface of the sulfide-based solid electrolyte, thereby more improving the recovery capability of the lithium-ion conductivity.

In the step (S41), the concentration of oxygen gas can be at least 10 ppm and at most 99.995%, and the flow rate of oxygen gas can be at least 10 sccm and at most 1,000 sccm. Specifically, the flow rate of the oxygen gas can be at least 10 sccm, at least 20 sccm, at least 30 sccm, at least 40 sccm, at least 50 sccm, at least 60 sccm, at least 70 sccm, at least 80 sccm, at least 90 sccm, at least 100 sccm, at least 110 sccm, at least 120 sccm, at least 130 sccm, at least 140 sccm, at least 150 sccm, at least 160 sccm, at least 170 sccm, at least 180 sccm, at least 190 sccm, or at least 200 sccm, and can be at most 1,000 sccm, at most 900 sccm, at most 800 sccm, at most 700 sccm, at most 600 sccm, at most 500 sccm, at most 400 sccm, at most 300 sccm, or at most 200 sccm.

In some implementations, referring to FIG. 1B, a process for regenerating the sulfide-based solid electrolyte is provided.

At block 110, the process can begin with preparing a sulfide-based solid electrolyte, which can include an argyrodite-type crystal structure containing lithium, phosphorus, sulfur, and halogen. At this stage, the sulfide-based solid electrolyte can be prone to reactivity with moisture.

At block 120, the sulfide-based solid electrolyte cab be deteriorated due to moisture, for example, by exposing the sulfide-based solid electrolyte to air and/or a dry room environment (e.g., dew point −50° C.), causing it to react with moisture.

At block 130, the deteriorated sulfide-based solid electrolyte can be placed into a heating furnace and subjected to vacuum annealing at 150° C., followed by an oxygen (O₂) gas flow for five minutes. For example, the furnace can vacuumized to remove air, and the temperature can be increased (e.g., from 30° C. to 150° C.) at a controlled rate (e.g., 5° C./min) to prevent thermal shock. The temperature of the furnace can be maintained at the target level (e.g., 150° C.) for a set duration (e.g., nearly 2 hours) to facilitate the removal of impurities. Then, oxygen gas can be introduced into the furnace (e.g., at 200 sccm) for a short period (e.g., 5 minutes) while maintaining the heat. In this way, oxygen atoms can be substituted at sulfur sites.

Vacuum annealing can effectively remove adsorbed H₂O and decomposed products (e.g., moisture-derived byproducts and other foreign substances from the surface), as shown at block 140.

In addition, the oxygen flow step can pre-oxidize reductive compounds/species present on the surface, such as sulfide ions, as shown at block 150, thereby stabilizing the chemical environment and preventing further degradation.

The treatments described above collectively can result in surface modification, as shown at block 160, where oxygen atoms substitute sulfur sites to form a stable surface layer including PSₓO_{y}. This modification can enhance air stability and lead to a regenerated/recovered sulfide-based solid electrolyte, as shown at block 170.

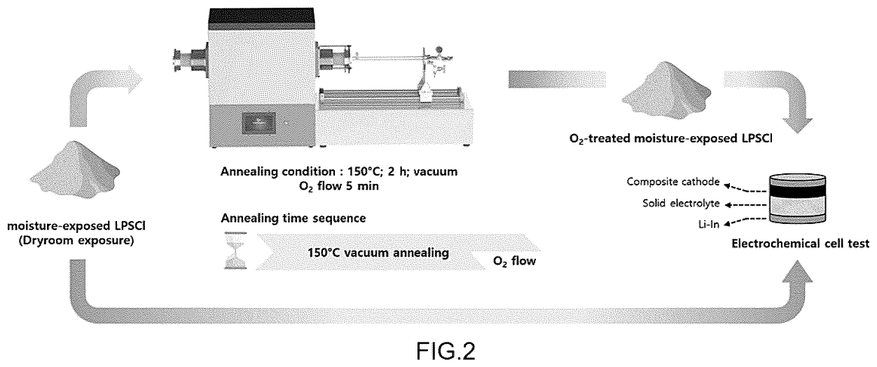

FIG. 2 is a schematic view illustrating a process for regenerating a sulfide-based solid electrolyte according to an implementation of the present disclosure.

The process can begin with a sulfide-based solid electrolyte, for example, lithium phosphorus sulfur chlorine (LPSCl), that has been exposed to moisture in a dry room environment. This exposure can lead to surface degradation and formation of byproducts.

Then, the moisture-exposed LPSCl can be placed in a heating furnace for regeneration. The annealing conditions can be at 150° C., for 2 hours, in a vacuum environment. After vacuum annealing, an oxygen (O₂) gas flow can introduced for 5 minutes while maintaining the heat. After treatment, the regenerated LPSCl can exhibit improved chemical stability and reduced presence of moisture-related byproducts. The surface layer formed during oxygen treatment can enhance resistance to further degradation. The regenerated sulfide-based solid electrolyte can be integrated into an electrochemical cell including a composite cathode, a solid electrolyte layer, and a lithium-indium (Li—In) anode. The electrochemical cell can be used for performance evaluation.

### EXAMPLES

Hereinafter, implementations of the present disclosure will be described in detail so that those of ordinary skill in the art to which the present disclosure pertains can readily reproduce the present disclosure. However, the present disclosure can be realized in various different forms, and is not limited implementations described herein.

### Comparative Example 1

The sulfide-based solid electrolyte having the composition of Li₆PS₅Cl and the ion conductivity is 2 mS/cm was prepared.

### Comparative Example 2

The sulfide-based solid electrolyte prepared according to Comparative example 1 was exposed to a dry room (dew point of −50° C.; absolute humidity of 47 mg/m³) for 24 hours, after being manufactured and stored in a glove box substituted with Ar gas (H₂O<1 ppm; O₂<1 ppm).

### Example 1

The sulfide-based solid electrolyte exposed in the dry room in Comparative example 2 was placed in an alumina tube of a tube furnace, and the alumina tube was connected to a vacuum pump to maintain a vacuum state. Thereafter, an internal temperature of the tube furnace was started at a temperature of 30° C., was increased to 150° C. at a temperature increasing rate of 5° C./min, and was maintained at 150° C. for 1 hour 55 minutes. Subsequently, the internal temperature of the heating furnace was maintained at 150° C. while allowing oxygen gas to flow in the alumina tube at the flow rate of 200 sccm about 5 minutes.

### Example 2

The sulfide-based solid electrolyte exposed in the dry room in Comparative example 2 was placed in an alumina tube of a tube furnace, and the alumina tube was connected to a vacuum pump to maintain a vacuum state. Thereafter, an internal temperature of the furnace was started at a temperature of 30° C., was increased to 550° C. at a temperature increasing rate of 5° C./min, and was maintained at 550° C. for 2 hours. Subsequently, the internal temperature of the heating furnace was maintained at 550° C. while allowing oxygen gas to flow in the alumina tube at the flow rate of 200 sccm about 5 minutes.

### Example 3

The sulfide-based solid electrolyte exposed in the dry room in Comparative example 2 was placed in an alumina tube of a tube furnace, and the alumina tube was connected to a vacuum pump to maintain a vacuum state. Thereafter, an internal temperature of the furnace was started at a temperature of 30° C., was increased to 150° C. at a temperature increasing rate of 5° C./min, and was maintained at 150° C. for 2 hours.

### Experimental Example 1: Analysis of Lithium-Ion Conductivity

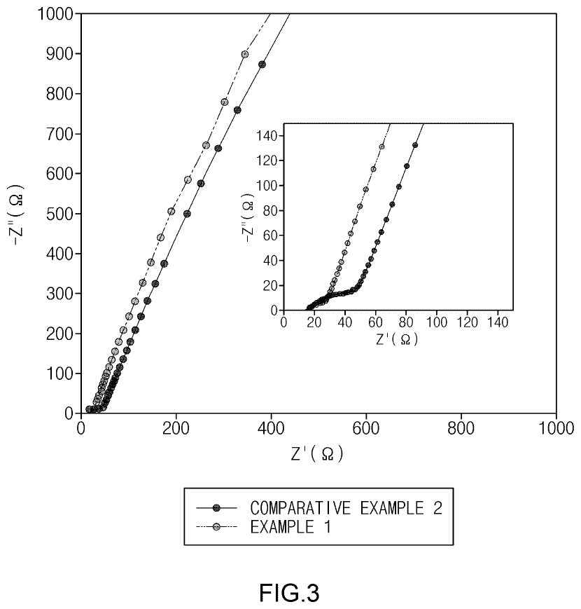

Each powder of the sulfide-based solid electrolyte exposed in the dry room in Comparative example 2 and the sulfide-based solid electrolyte regenerated in Example 1 was put in an amount of 0.1 g into a PEEK mold having a diameter of 10 mm in a glove box substituted with Ar gas (H₂O<1 ppm, O₂<1 ppm), and was pressed uniaxially at the pressure of 375 MPa to make a powder pellet. For each of the made powder pellets, an AC impedance was measured by using an SP-200 of BioLogic under the conditions of a measurement frequency ranging from 0.1 Hz to 1 MHz and an AC amplitude of 10 mV at room temperature (25° C.), and the results are illustrated in FIG. 3.

The lithium-ion conductivity was calculated through the following Equation 1 based on the results of the AC impedances illustrated in FIG. 3 and is illustrated in the following Table 1.

The lithium-ion conductivity for the sulfide-based solid electrolyte regenerated in Example 2, which was measured and calculated in the same manner, is shown in Table 1 together.

$${σ}_{L i} ( S / c m ) = L ( RXA ) \qquad [ Equation 1 ]$$

In Equation 1, ‘L’ is a thickness (cm) of the pellet, ‘A’ is an area (cm²) of the pellet, and ‘R’ is the resistance of the bulk electrolyte determined by an intersection (Rb) at which a semicircle or a straight line of the measured impedance locus meets a real axis.

TABLE 1

| Classification | Lithium-ion conductivity (mS/cm) |
|---|---|
| Comparative example 2 | 1.075 |
| Example 1 | 1.620 |
| Example 2 | 1.087 |

Referring to FIG. 3 and Table 1, it can be confirmed that the sulfide-based solid electrolytes of Examples 1 and 2 exhibited the recovery of the lithium-ion conductivity, when compared to the sulfide-based solid electrolyte of Comparative example 2. In particular, it can be confirmed that the sulfide-based solid electrolyte of Example 1 exhibited a significantly higher recovery level of the lithium-ion conductivity, when compared to the sulfide-based solid electrolytes of Comparative example 2 and Example 2.

Specifically, it can be confirmed that when the sulfide-based solid electrolyte deteriorated due to the moisture reaction, such as the exposure in the dry room, in Comparative example 2, was regenerated as in Example 1, the byproduct was removed from the surface while a surface stabilization layer was reformed, thereby improving the lithium-ion conductivity. In addition, it can be confirmed that the reactivity of sulfur (S) was suppressed through the substitution of oxygen to additionally control the emission of hydrogen sulfide due to the reaction with moisture.

In addition, a semicircular arc in a high-frequency region is known to originate from a particle surface resistance. In this case, it can be confirmed that such a semicircular arc was disappeared when the regeneration is performed as in Example 1, and it can be conformed that the surface adsorbate having the lower conductivity was removed from the surface of the sulfide-based solid electrolyte after the regeneration.

### Experimental Example 2: Analysis of Oxidation State of Ni

To confirm that a substance having strong reducing power present on the surface of the sulfide-based solid electrolyte deteriorated due to moisture was effectively oxidized first through the method for regenerating the sulfide-based solid electrolyte of the present disclosure, composite positive electrodes were manufactured using the sulfide-based solid electrolyte before exposure in the dry room of Comparative example 1, the sulfide-based solid electrolyte exposed in the dry room of Comparative example 2, and the sulfide-based solid electrolyte regenerated in Example 1.

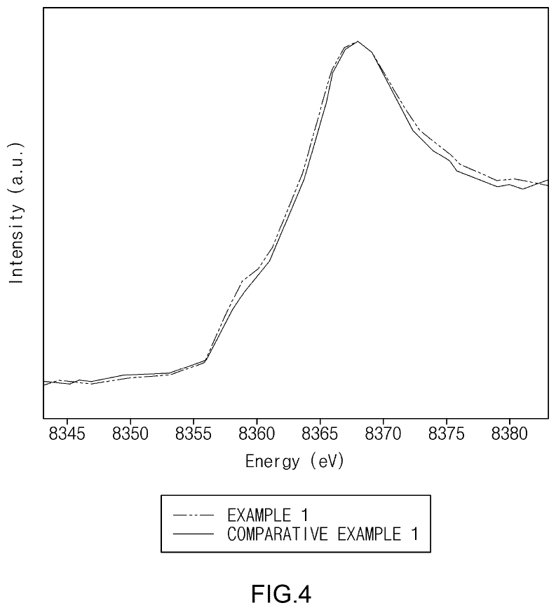

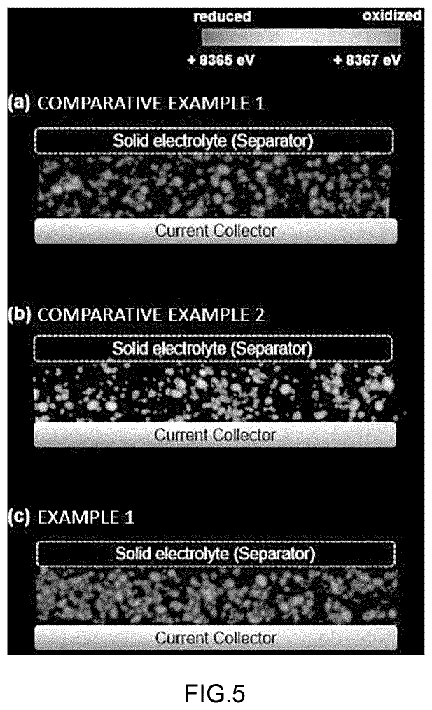

Specifically, a solvent was added to a positive electrode active material (LiNi_{0.7}Co_{0.15}Mn_{0.15}O₂), a sulfide-based solid electrolyte, a binder (NBR), and a conductive material (Super C65) at a weight ratio of 76:20:1.5:2.5, and the result was mixed by using a mixer at 2,000 rpm for 5 minutes to prepare a slurry. The slurry was applied to an aluminum foil (Al foil; 13 μm) using a doctor blade and vacuum-dried at 140° C. to manufacture the composite electrode. A thin piece having a thickness of 2 to 3 μm was prepared to obtain the cross-section of the manufactured composite electrode. The oxidation state of Ni of the positive electrode active material was analyzed using the thin piece of the manufactured electrode through a TXM (Transmission X-ray Microscopy), and the results are shown in FIGS. 4 and 5.

When a unit electrode is exposed to moisture, the positive electrode active material can be deteriorated in addition to the sulfide-based solid electrolyte. The moisture causes a chemical reaction at the interface between the solid electrolyte and the positive electrode active material to lower the performance of the electrolyte and cause the structural damage of the positive electrode active material. These are important issues in the long-term stability of the all-solid state battery and maintaining the performance of the all-solid state battery.

Referring to FIGS. 4 and 5, it can be confirmed that the oxidation state of Ni was changed to a reduction state as the evidence of the chemical reaction, in the electrode using the sulfide-based solid electrolyte of Comparative example 2, when compared to the electrode using the sulfide-based solid electrolyte of Comparative example 1. Accordingly, it can be confirmed that the byproduct on the surface of the sulfide-based solid electrolyte exerted an adverse influence on the positive electrode active material. The chemical reactions caused by moisture infiltration led to changes in the oxidation state of the positive electrode active material, which directly results in a deterioration of the electrochemical performance of the electrode, thereby reducing the mobility of lithium ions and the overall charge/discharge efficiency of the battery.

It can be confirmed the sulfide-based solid electrolyte of Example 1, which was regenerated through the method for regenerating the sulfide-based solid electrolyte of the present disclosure, showed the oxidation state of Ni similar to that of the positive electrode active material of the positive electrode employing the sulfide-based solid electrolyte of Comparative example 1. Accordingly, it can be confirmed that an effective stable layer, that is, an effective oxidation layer was introduced. In addition, it can be confirmed that the similar spectrum of Ni XANES was appeared when the sulfide-based solid electrolytes according to Example 1 and Comparative example 1 were employed, which can indicate that the byproduct on the surface was effectively removed through the regeneration.

### Experimental Example 3: Measurement of Initial Discharge Capacity and C-Rate

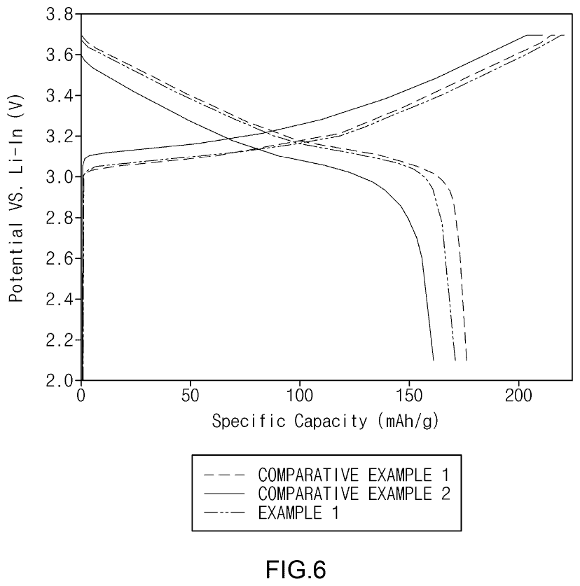

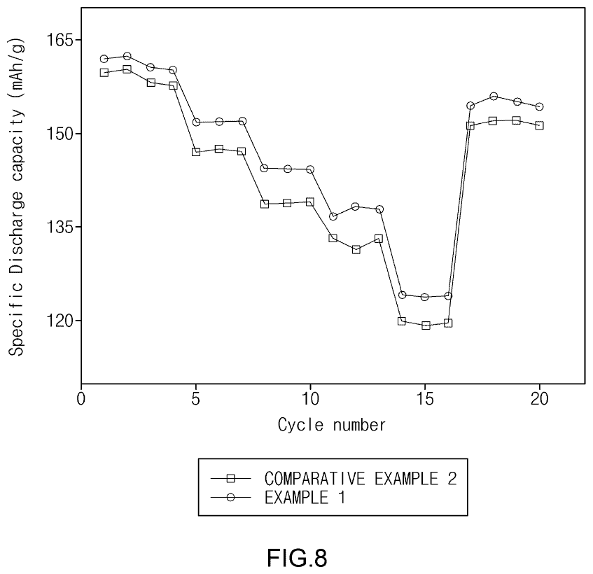

To evaluate the discharge capacity of the sulfide-based solid electrolyte regenerated through the method for regenerating the sulfide-based solid electrolyte, a Li—In (Lithium-Indium) half-cell was manufactured. Specifically, a positive electrode active material (LiNi_{0.7}Co_{0.15}Mn_{0.15}O₂), a sulfide-based solid electrolyte, and VGCF at a weight ratio of 78:20:2 were uniformly mixed through a grinding process using a manual mill for 30 minutes to manufacture a positive electrode composite material. Each powder of the sulfide-based solid electrolyte exposed in the dry room in Comparative example 2 and the sulfide-based solid electrolyte regenerated in Example 1 was put in an amount of 0.1 g into a PEEK mold having a diameter of 10 mm in a glove box substituted with Ar gas (H₂O<1 ppm, 02<1 ppm), and was pressed uniaxially at the pressure of 375 MPa to make a powder pellet. Subsequently, the positive electrode composite material was distributed on one surface of the powder pellet and compressed at a pressure of 560 MPa. In addition, Li_{0.5}In foil was attached to an opposite surface of the powder pellet and compressed at a pressure of 180 MPa. The manufactured cell was charged and discharged using a WonATech WBCS 3000 battery analysis system under the conditions of a current density of 0.1 C and a voltage ranging from 2.1 V to 3.7 V (vs. In—Li). The initial charge and discharge results are shown in FIG. 6, and the initial discharge capacity and efficiency are shown in Table 2. In addition, the result of a C-rate characteristic is shown in FIG. 8.

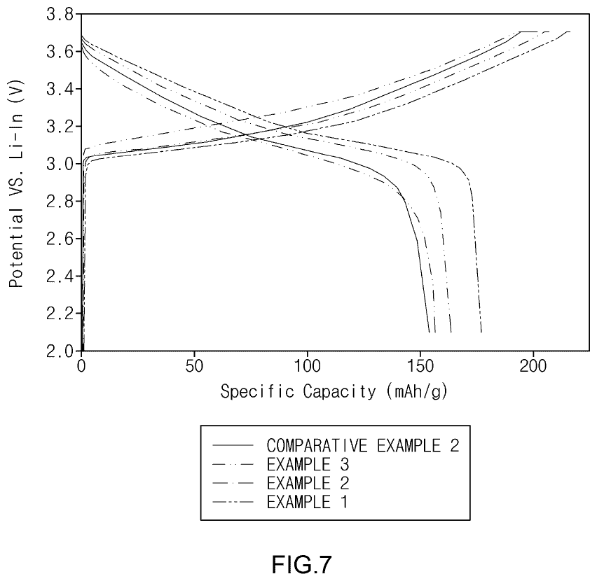

The charging and discharging operations were performed in the same manner with respect to the sulfide-based solid electrolytes regenerated in Examples 2 and 3, the initial charge and discharge results thereof are illustrated in FIG. 7, and the initial discharge capacity and efficiency are also shown together in the following Table 2.

TABLE 2

| | Initial discharging capacity | Efficiency |
|---|---|---|
| Classification | (mAh/g) | (%) |
| Comparative example 1 | 176.06 | 81.17 |
| Comparative example 2 | 153.66 | 77.73 |
| Example 1 | 170.80 | 77.28 |
| Example 2 | 156.64 | 77.66 |
| Example 3 | 163.03 | 78.92 |

Referring to FIGS. 6 and 7, and Table 2, it can be confirmed that the cell employing the sulfide-based solid electrolytes according to Examples 1 to 3 regenerated through the method for regenerating the sulfide-based solid electrolyte of the present disclosure were recovered in the initial discharge capacity, when compared to a cell employing the sulfide-based solid electrolyte of Comparative example 2 exposed in the dry room. In particular, it can be confirmed that the battery employing the sulfide-based solid electrolyte of Example 1 was greatly recovered in the initial discharge capacity.

In addition, referring to FIG. 8, it can be confirmed that when the C-rates were sequentially measured to 0.1, 0.2, 0.33, 0.5, 1, and 0.2 C-rate, higher discharge capacities were ensured at all C-rates in the sulfide-based solid electrolyte of Example 1, as compared to the sulfide-based solid electrolyte of Comparative example 2, and the difference of the discharge capacity was made up to 15 mAh/g between the sulfide-based solid electrolyte of Example 1 and the sulfide-based solid electrolyte of Comparative example 2.

### Experimental Example 4: XPS Analysis 1

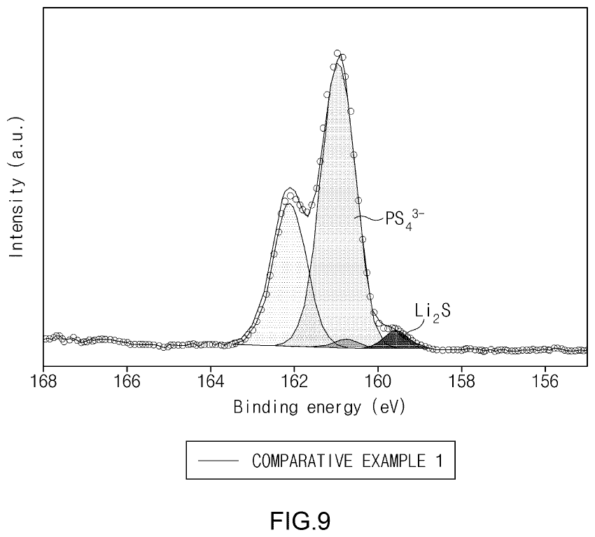

XPS analysis was performed with respect to the sulfide-based solid electrolytes of Comparative example 1 and Example 1. The XPS analysis was measured using AXIS Supra+ by Kratos. The XPS analysis can be performed by maintaining a non-atmospheric exposure state through a chamber connected to a glove box during XPS measurement, by performing a step size at 0.1 eV, and by adjusting Ar sputtering conditions to Ar⁺ mono ion, an energy of 5 keV, and an emission current of 12 mA, and the results of the XPS analysis are shown in FIGS. 9 to 12.

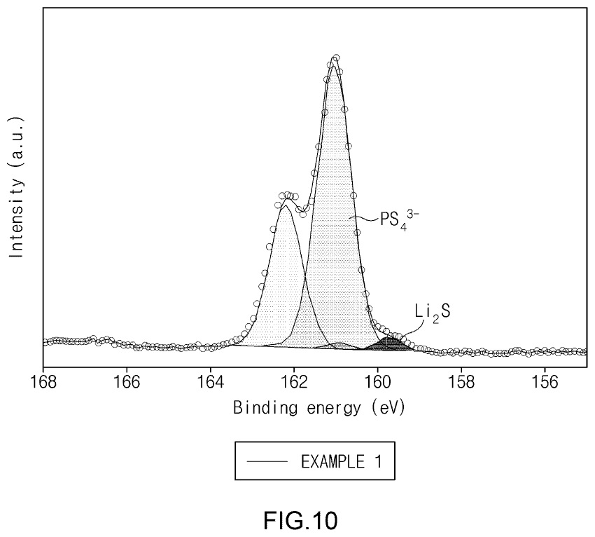

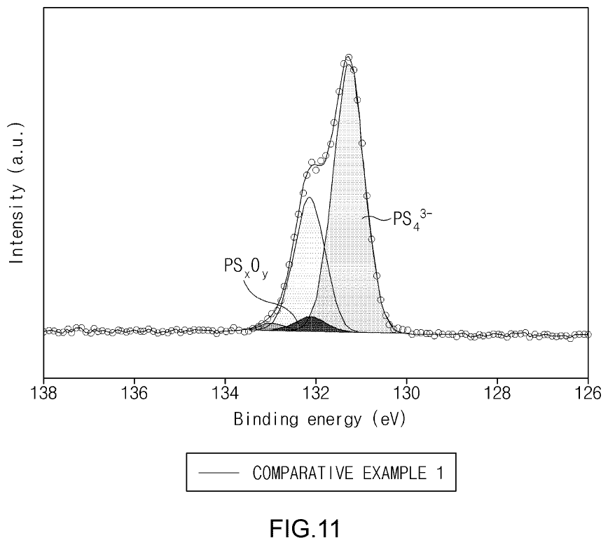

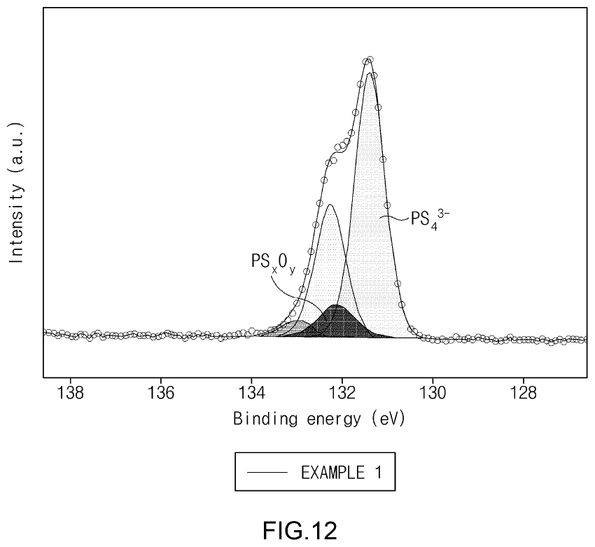

In addition, the ratios of the compounds in the S 2p confirmed in FIGS. 9 and 10 are shown in the following Table 3, and the ratios of the compounds in the P 2p confirmed in FIGS. 11 and 12 are shown in the following Table 4.

TABLE 3

| Classification | PS₄³⁻ | Li₂S |
|---|---|---|
| Comparative example 1 | 95.16 | 4.84 |
| Example 1 | 96.53 | 3.47 |

TABLE 4

| Classification | PS₄³⁻ | PSₓO_{y} |
|---|---|---|
| Comparative example 1 | 94.99 | 5.01 |
| Example 1 | 87.58 | 12.56 |

Referring to FIG. 7, Table 3, and Table 4, it can be confirmed that in the sulfide-based solid electrolyte of Example 1, the content of Li₂S, which is a representative byproduct due to the moisture deterioration, was reduced, and the peak ratio based on PSₓO_{y} formed by the substitution of the 0 element at the Sulfur (S) site was significantly increased from 5.01 to 12.56 thereby effectively regenerating the sulfide-based solid electrolyte.

### Experimental Example 5: XPS Analysis 2

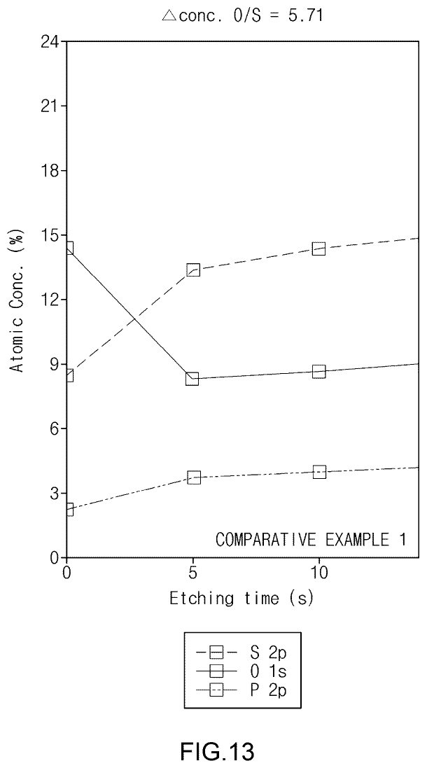

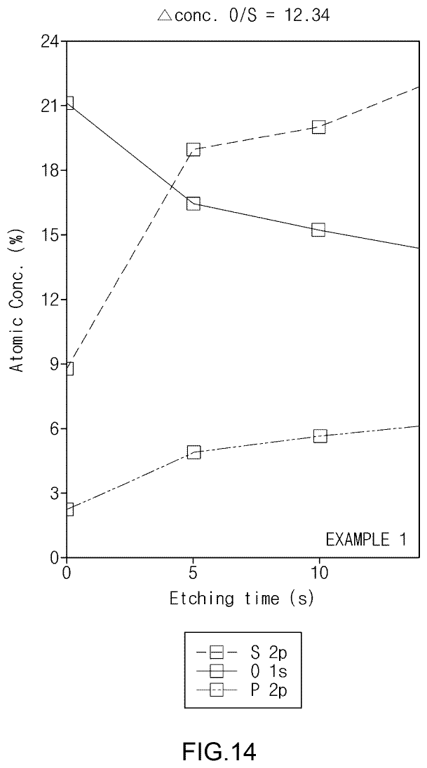

XPS analysis was performed with respect to the sulfide-based solid electrolytes of Comparative example 1 and Example 1. The XPS analysis was measured using AXIS Supra+ by Kratos. The XPS analysis can be performed by maintaining a non-atmospheric exposure state through a chamber connected to a glove box during XPS measurement, by performing a step size at 0.1 eV, and by adjusting Ar sputtering conditions to Ar⁺ mono ion, an energy of 5 keV, and an emission current of 12 Ma to measure the atom ratio depending on a depth, and the results of the XPS analysis are shown in FIGS. 13 to 14.

Referring to FIG. 13, it can be confirmed that in the sulfide-based solid electrolyte of Comparative example 1, the difference in concentration between the O atom and the S atom in the PSₓO_{y} present on the surface was 5.71%. In contrast, referring to FIG. 14, it can be confirmed that in the sulfide-based solid electrolyte of Example 1, the concentration of the P atom was maintained through the regeneration, while the concentration of the O atom at the surface was significantly increased, such that the difference in concentration between the O atom and the S atom in the PSₓO_{y} present on the surface was 12.34%. Accordingly, it can be confirmed that the O atom was substituted and introduced at the sulfur (S) site on the surface of the sulfide-based solid electrolyte, such that a new surface layer, that is, the oxide layer, was effectively formed.

### Experimental Example 6: Analysis of Tender XAS

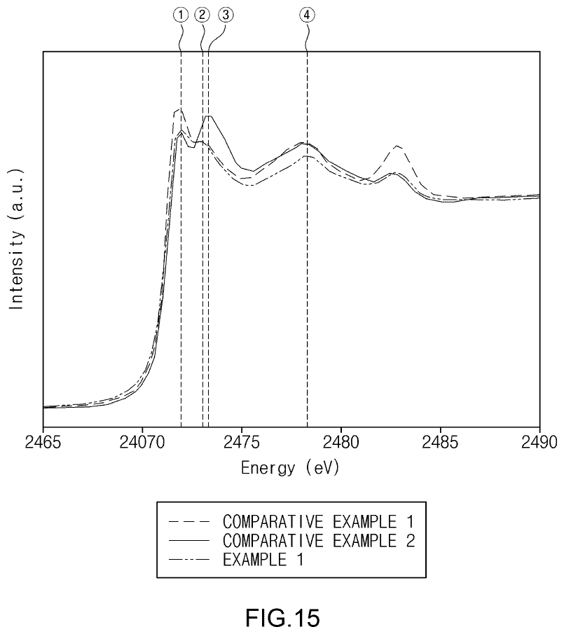

The Sulfur K-edge was measured through Tender X-ray Absorption Spectroscopy (Tender XAS) analysis with respect to the sulfide-based solid electrolytes of Comparative example 1, Comparative example 2, and Example 1, and the results are shown in FIG. 15. Regarding the Tender XAS analysis, a Sulfur K-edge X-ray absorption spectrum (2,460 eV to 2,490 eV) was performed using ender-energy XAS 1× of Pohang Light Source II (PLS-II), an incident X-ray was monochromatized by using an Si(111) double-crystal monochromator (DCM), and the spectrum was collected in a fluorescence-yield mode. The energy step was set to 0.1 eV, and the obtained p (E) data was analyzed by using Athena. The intensity (I_{σ*}; white line intensity) of a peak, which serves as a first peak, identified at at least 2,470.0 eV and less than 2,472.5 eV is illustrated in the following Table 5. In addition, a ratio (Ie_{2,47}/I_{σ*}) of an intensity (I_{e2,473}) of a peak, which serves as a second peak, identified at 2,473 eV to the intensity (I_{σ*}) of the peak, which serves as the first peak, identified in a range from 2,470.0 eV to less than 2,472.5 eV was calculated and is illustrated in the following Table 5. Calculation was performed with respect to the ratios of the value (AR) of the ratio (Ie_{2,473}/I_{σ*}) calculated with respect to the sulfide-based solid electrolyte of Comparative example 2 and the value of the ratio (Ie_{2,473}/I_{σ*}) calculated with respect to the sulfide-based solid electrolyte of Example 1, to the value (BE) of the ratio (Ie_{2,473}/I_{σ*}) calculated with respect to the sulfide-based solid electrolyte of Comparative example 1 corresponding to Pristine, and the calculation result is shown in Table 5.

TABLE 5

| Classification | I_{σ*} | Ie_{2,473/}I_{σ*} | AR/BE |
|---|---|---|---|
| Comparative | 1.4268 | 0.89 | — |
| example 1 | | | |
| Comparative | 1.3140 | 1.06 | 1.191 |
| example 2 | | | |
| Example 1 | 1.3307 | 0.94 | 1.056 |

Referring to FIG. 15, it can be confirmed that in the sulfide-based solid electrolyte of Comparative example 2, Li₂S was produced after exposed in the dry room and the peak intensity was increased at the position of a third peak to exhibit a deterioration phenomenon, as compared with the sulfide-based solid electrolyte of Comparative example 1, and it can be confirmed that in the sulfide-based solid electrolyte of Example 1, the peak intensity at the position of the third peak was recovered to the level of Comparative example 1, thereby removing low-conductivity adsorbate from the surface of the sulfide-based solid electrolyte.

Meanwhile, the first peak identified in the range from 2,470.0 eV to less than 2,472.5 eV is a Sulfur K-edge main peak for a P atom and four S atoms adjacent to the P atom and corresponds to the σ* orbital which is the PS antibonding of the tetrahedral local symmetry. In this case, it can be confirmed that as shown in Table 5, in Example 1 in which the O atom was substituted with the sulfur (S) site, the ratio of an intensity (Ie_{2,473}) of the peak identified at 2,473 eV to the intensity (I_{σ*}) of the peak identified in the range from 2,470.0 eV to less than 2,472.5 eV was in the range from 0.89 to 1.05. Accordingly, as the oxygen (O) atom was substituted and introduced at the sulfur (S) site on the surface of the sulfide-based solid electrolyte to effectively form the novel surface layer, that is, the oxide layer.

### Experimental Example 7: Raman Analysis

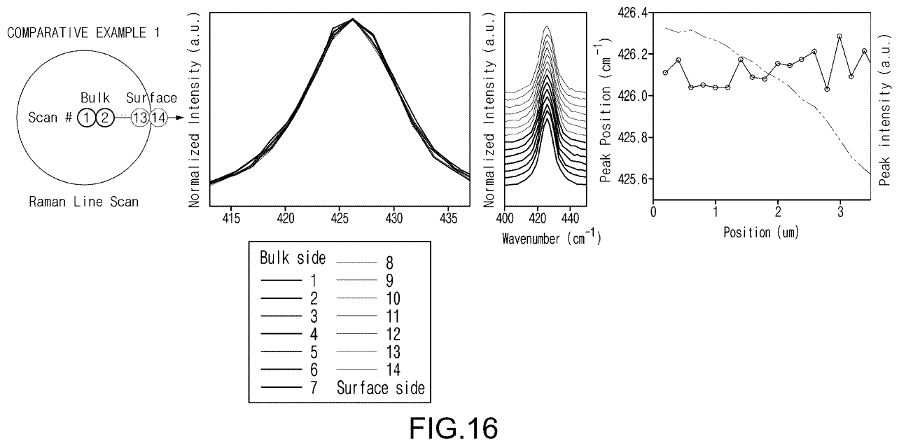

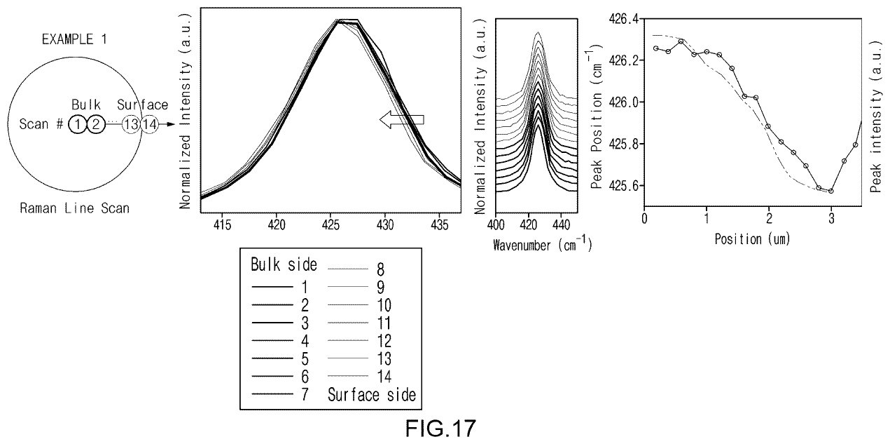

To observe the crystal change of the sulfide-based solid electrolyte of Example 1 regenerated through the method for regenerating the sulfide-based solid electrolyte of the present disclosure, in each of the sulfide-based solid electrolyte of Comparative example 1 and the sulfide-based solid electrolyte of Example 1, the PS₄³⁻ peak at 426 cm⁻¹ for the surface and the bulk of the solid electrolyte was measured through a Raman line scan, and the results are shown in FIG. 16 (Comparative example 1) and FIG. 17 (Example 1).

As illustrated in FIG. 16, it can be confirmed that a shift having the clear tendency of a main peak was not observed on the surface of the sulfide-based solid electrolyte of Comparative example 1 such that the structure was maintained on the surface.

In contrast, as confirmed in FIG. 17, a shift in which the PS₄³⁻ peak appearing closer to the surface was observed at a vibration energy ranging from 424.5 cm⁻¹ to 425.5 cm⁻¹ was observed in the sulfide-based solid electrolyte of Example 1 regenerated, which is determined as being caused due to the concentration of oxygen (O) increased on the surface when considering that the partial substitution of the O atom was caused at the Sulfur (S) site such that the PS₄³⁻ Raman peak was shifted toward a lower wavenumber.

### Experimental Example 8: XRD Analysis

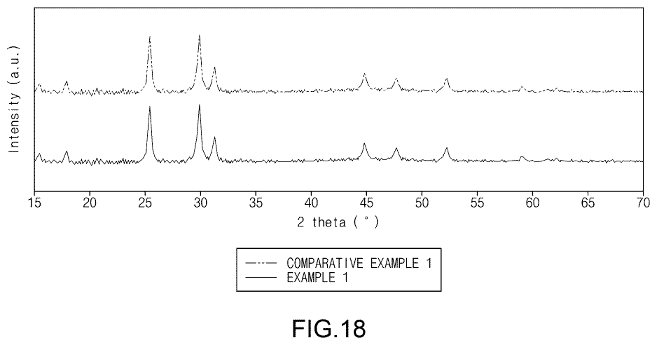

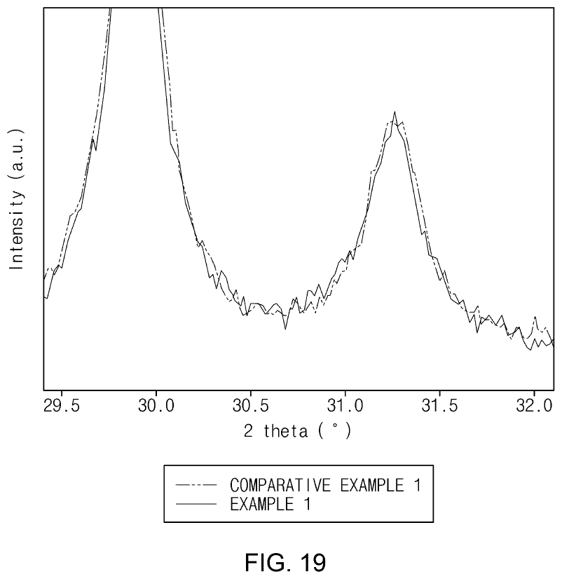

To observe the change in crystal of the sulfide-based solid electrolyte of Example 1 regenerated through the method for regenerating the sulfide-based solid electrolyte of the present disclosure, the XRD analysis was performed with respect to each of the sulfide-based solid electrolyte of Comparative example 1 and the sulfide-based solid electrolyte of Example 1. The XRD analysis was performed by using a D8 ADVANCED of Bruker aux Co., and the X-rays were generated as Cu-Ka radiation by using a monochromator at 40 mA and 40 kV. The measurement range was 10° to 80°, the measurement was performed at an interval of 0.02°, and the results are illustrated in FIG. 18. In addition, the results in a region in which 2θ ranges from 29.5° to 32.0° are enlarged and illustrated in FIG. 19.

Referring to FIGS. 18 and 19, it can be confirmed that a change in crystallinity and the generation of a new phase were not confirmed, and a change was not made in d₍₂₂₂₎, in the sulfide-based solid electrolyte of Example 1, when compared to the sulfide-based solid electrolyte of Comparative example 1. When the O atom was incorporated even into the sulfide-based solid electrolyte, a (222) plane peak should shift to a higher 2θ angle due to the substitution of the O, and the interplanar spacing should decrease such that the contraction of d₍₂₂₂₎ should be observed. However, this phenomenon was not observed. Accordingly, it can be confirmed that the oxygen (O) atom was substituted at the sulfur (S) site on the surface of the sulfide-based solid electrolyte. Accordingly, according to the method for regenerating the sulfide-based solid electrolyte of the present disclosure, it can be confirmed that the byproduct was selectively removed from the surface of the sulfide-based solid electrolyte without additionally deforming particles.

According to the method for regenerating the sulfide-based solid electrolyte of the present disclosure, even though the surface of the sulfide-based solid electrolyte is deteriorated due to the exposure to moisture, the surface of the sulfide-based solid electrolyte is regenerated to recover the lithium-ion conductivity, thereby improving the driving performance of the all-solid state battery including the sulfide-based solid electrolyte.

According to the sulfide-based solid electrolyte of the present disclosure, even though the sulfide-based solid electrolyte is deteriorated due to the exposure to moisture, the surface of the sulfide-based solid electrolyte is regenerated to recover the lithium-ion conductivity, thereby improving the driving performance of the all-solid state battery including the sulfide-based solid electrolyte.

According to the method for regenerating the sulfide-based solid electrolyte of the present disclosure, even though the surface of the sulfide-based solid electrolyte is deteriorated due to the exposure to moisture, the surface of the sulfide-based solid electrolyte is regenerated to recover the lithium-ion conductivity, thereby improving the driving performance of the all-solid state battery including the sulfide-based solid electrolyte.

Hereinabove, although the present disclosure has been described with reference to exemplary implementations and the accompanying drawings, the present disclosure is not limited thereto, but can be variously modified and altered by those skilled in the art to which the present disclosure pertains without departing from the spirit and scope of the present disclosure claimed in the following claims.

What is claimed is:

1. An electrolyte composition comprising:
a sulfide-based solid electrolyte having a surface layer comprising a phosphorous oxysulfide compound represented by a formula PSₓO_{y},
wherein x is an integer and y is an integer, and
wherein concentration of an oxygen (O) atom in the PSₓO_{y} is at least 15 atomic percent in an X-ray Photoelectron Spectroscopy (XPS) analysis.

2. The electrolyte composition of claim 1, wherein a difference in concentration between the oxygen (O) atom and a sulfur (S) atom in the PSₓO_{y} present on the surface layer of the sulfide-based solid electrolyte is at least 6 atomic percent, based on the XPS analysis.

3. The electrolyte composition of claim 1, wherein a ratio of PS₄³⁻ to PSₓO_{y} at P 2p in the XPS analysis with respect to the surface layer of the sulfide-based solid electrolyte is in a range from 1:1 to 18:1, based on the XPS analysis.

4. The electrolyte composition of claim 1, wherein a ratio (AR/BE) of:
(i) a value (AR) representing a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV measured for the sulfide-based solid electrolyte after regeneration, to
(ii) a value (BE) representing a ratio (Ie_{2,473}/I_{σ*}) of an intensity (I_{e2,473}) of a peak identified at 2,473 eV to an intensity (I_{σ*}) of a peak identified in the range from 2,470.0 eV to less than 2,472.5 eV measured for a sulfide-based solid electrolyte before regeneration, which has a same composition as the sulfide-based solid electrolyte,
ranges from 1.00 to 1.18, based on a Sulfur K-edge analysis measured through a Tender X-ray Absorption Spectroscopy (XAS).

5. The electrolyte composition of claim 1, wherein a ratio (Ie_{2,473}/I_{σ*}) of an intensity (I_{e2,473}) of a peak identified at 2,473 eV to an intensity (I_{σ*}) of a peak identified in a range from 2,470.0 eV to less than 2,472.5 eV, measured for the sulfide-based solid electrolyte, ranges from 0.89 to 1.05, based on a Sulfur K-edge analysis measured through a Tender X-ray Absorption Spectroscopy (XAS).

6. The electrolyte composition of claim 1, wherein a value of an intensity (I_{σ*}) of a peak identified in a range from 2,470.0 eV to less than 2,472.5 eV, measured for the sulfide-based solid electrolyte, ranges from 1.315 to 1.426, based on a Sulfur K-edge analysis measured through a Tender X-ray Absorption Spectroscopy (XAS).

7. The electrolyte composition of claim 1, wherein a peak of PS₄³⁻ is observed at a vibration energy ranging from 425.6 cm⁻¹ to 426.3 cm⁻¹, based on a Raman Line scan analysis performed from a center of a particle of the sulfide-based solid electrolyte to a surface of the particle.

8. The electrolyte composition of claim 1, wherein the sulfide-based solid electrolyte is represented by following Chemical formula 1. 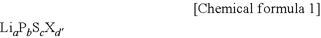
in Chemical formula 1,
4.0≤a≤6.0, 0.5≤b≤1.5, 3.0≤c≤9.0, and 0.5≤d≤2.0, and ‘X’ is at least one of Cl, Br, or I.

9. An electrode comprising the electrolyte composition according to claim 1, and an electrode active material.

10. An all-solid state battery comprising:
a positive electrode;
a negative electrode; and
a solid electrolyte layer interposed between the positive electrode and the negative electrode,
wherein at least one of the positive electrode, the negative electrode, and the solid electrolyte layer comprises a sulfide-based solid electrolyte having a surface layer comprising a phosphorous oxysulfide compound represented by a formula PSₓO_{y},
wherein x is an integer and y is an integer, and
wherein concentration of an oxygen (O) atom in the PSₓO_{y} is at least 15 atomic percent in an X-ray Photoelectron Spectroscopy (XPS) analysis.

11. A method for regenerating a sulfide-based solid electrolyte, the method comprising:
preparing a sulfide-based solid electrolyte that has deteriorated due to moisture;
placing the sulfide-based solid electrolyte deteriorated due to the moisture into a heating furnace;
heating the heating furnace;
maintaining the heating furnace to be in a heated state; and
recovering the sulfide-based solid electrolyte after regeneration.

12. The method of claim 11, comprising:
vacuumizing an inner part of the heating furnace before the heating.

13. The method of claim 11, wherein the heating comprises a process performed at a temperature increasing rate ranging from 1° C./min to 20° C./min.

14. The method of claim 11, wherein a starting temperature of the heating ranges from 10° C. to 40° C.

15. The method of claim 11, wherein a termination temperature of the heating ranges from 50° C. to 600° C.

16. The method of claim 11, wherein maintaining the heating furnace comprises a process performed at a termination temperature of the heating.

17. The method of claim 11, comprising:
allowing oxygen gas to flow in the heating furnace during the maintaining the heating furnace.

18. The method of claim 17, wherein allowing the oxygen gas to flow in the heating furnace comprises a process performed at a temperature a same as a temperature for the maintaining the heating furnace.

19. The method of claim 17, wherein allowing the oxygen gas to flow in the heating furnace comprises a process performed for a period of time that is at most 10% of a period of time for the maintaining the heating furnace.

20. The method of claim 17, wherein a flow rate of the oxygen gas ranges from 10 sccm to 1,000 sccm.
